(19) United States
(12) Patent Application Publication
(10) Pub. No.: US 2002/0019937 A1
(43) Pub. Date: Feb. 14, 2002

(54) Secure document transport process

(76) Inventors: Trevor W. Edstrom, Providence, UT (US); Andy L. Rasmussen, Smithfield, UT (US); Calvin N. Slater, North Logan, UT (US)

Correspondence Address: WORKMAN NYDEGGER & SEELEY, A PROFESSIONAL CORPORATION, 1000 EAGLE GATE TOWER, 60 EAST SOUTH TEMPLE, SALT LAKE CITY, UT, 84111, US

(21) Appl. No.: 09/875,603

(22) Filed: Jun. 6, 2001

Related U.S. Application Data
(60) Provisional application No. 60/210,177, filed on Jun. 6, 2000.

(51) Int. Cl. H04L 9/00

(52) U.S. Cl. 713/168; 713/176; 380/241

(57) ABSTRACT

Transport software is provided which facilitates secure transfer of legally enforceable electronic documents between servers in a computer network. The transport software includes four scripts. A doc.send script at the originating server causes preparation of a package having an electronic document and routing information, and transfers the package to the destination server. Consistent with a doc.receive script, the destination server performs an initial validation of the package and, if validation is successful, processes the electronic document. The electronic document is then returned to the originating server in accordance with a doc.return script, and received and processed at the originating server consistent with another doc.receive script. If the electronic document does not pass the initial validation, it is returned to the originating server in accordance with the doc.receive script at the destination server and received and processed at the originating server consistent with the doc.receive script of the originating server.

### CROSS-REFERENCE TO RELATED APPLICATIONS

As provided for by 35 U.S.C. § 120, this patent application hereby claims priority to U.S. Provisional Patent Application Ser. No. 60/210,177, entitled Secure Document Transport Process, filed Jun. 6, 2000, and incorporated herein in its entirety by this reference.

### BACKGROUND OF THE INVENTION

1. The Field of the Invention

Generally, the present invention relates to methods, systems, and computer software for transporting electronic documents. More particularly, embodiments of the present invention are directed to methods and systems for securely transferring validatable electronic documents from one location on a computer network to another location on the computer network.

2. Related Technology

Signatures are often a formal requirement of various transactions. Many legal instruments, such as wills, contracts, and deeds, are not legally enforceable unless they are signed by the appropriate persons in a specified way. While the specific legal requirements relating to signatures may vary across jurisdictions, the requirement of having a signature on a document serves fundamental purposes. For instance, signatures should be indicative of the person that signed a particular document and signatures should be difficult to reproduce without authorization. Signatures should also identify what is signed such that it is difficult to alter the signed matter without being discovered. Signatures further serve to authenticate a document by identifying each person that signed the document and the act of signing a document is intended to bring the legal aspects of signing the document to the attention of the signer.

Electronic documents are signed using digital “signatures” that are analogous to the handwritten signatures used in conjunction with paper documents. Typically, the digital signature is attached to the document with which it is associated. This arrangement however, weakens the digital signature as an authenticator because the attached signature must be separated from the document at the time of validation.

Some of the problems with digital signatures also have implications with respect to the transfer of electronic documents within a computer network. For example, if the digital signature is defective in any way, the transfer of documents may be slowed, or otherwise impaired, by the inability of the originating and destination servers, between which an electronic document is transferred, to readily verify or validate the electronic document with which the digital signature is associated.

### BRIEF SUMMARY OF EMBODIMENTS OF THE INVENTION

The present invention has been developed in response to the current state of the art, and in particular, in response to these and other problems and needs that have not been fully or adequately resolved by currently available bearing assemblies. Briefly summarized, embodiments of the present invention provide for transport software and related processes and methods which include features directed toward facilitating the secure transfer of validatable electronic documents between servers in a computer network.

Embodiments of the invention are particularly well suited for use in the context of county recording systems for real property transactions. However, embodiments of the present invention are suitable for use in any environment where it is desired to reliably and securely transfer validatable or other sensitive electronic documents within a computer network.

In one embodiment of the invention, transport software is provided that includes web server instructions, preferably in the form of four Active Server Page (“ASP”) scripts, each of which causes a server to perform various functions respecting a validatable electronic document. In general, the transport software facilitates the secure transfer of the electronic document between the servers

The electronic document is created at the originating server. A doc.send script of the transport software then causes the originating server to generate a package which includes at least the electronic document and routing information indicating the address of a destination server. The electronic document is then encrypted and the package is posted to the destination server. Preferably, encryption and decryption of the electronic document is achieved through the use of Secure Sockets Layer (“SSL”) encryption technology. Immediately after the package is posted, a doc.receive script of the transport software causes the destination server to return a corresponding response to the originating server, preferably either a tracking number or error string.

In particular, if the electronic document fails an initial validation step at the destination server, a corresponding error string or rejection notice is immediately returned to the originating server. The electronic document is not returned if it fails the initial validation.

On the other hand, if the electronic document passes the initial validation at the destination server, then a tracking number is returned to the originating server and the electronic document is placed into a destination server processing queue. When the time arrives for processing of the electronic document, the doc.receive script causes the destination server to decrypt the electronic document. After the electronic document has been decrypted, the originating server then processes the electronic document.

Processes performed with regard to the electronic document may include digitally validating the electronic document, digitally endorsing the electronic document, indexing the electronic document, imaging the electronic document, indexing the electronic document, and archiving the electronic document. After processing, the destination server returns the processed electronic document to the originating server as directed by the doc.return script.

Specifically, at such time as the processing of the electronic document is completed, the doc.return script then causes the destination server to encrypt the electronic document. The encrypted electronic document is then packaged together with a receipt and routing information, and the package returned to the originating server.

A doc.receive script associated with the originating server causes the originating server to decrypt the electronic document and ascertain any changes made to the electronic document. After the electronic document has been examined, the doc.receive script causes the originating server to update the status of the electronic document accordingly and then place the electronic document into an appropriate table. Finally, the doc.receive script causes the originating server to update an audit log to indicate the various processes performed with respect to the electronic document.

These and other features and advantages of the present invention will become more fully apparent from the following description and appended claims.

### BRIEF DESCRIPTION OF THE DRAWINGS

In order that the manner in which the above-recited and other advantages and features of the invention are obtained, a more particular description of the invention briefly described above will be rendered by reference to specific embodiments thereof which are illustrated in the appended drawings. Understanding that these drawings depict only typical embodiments of the invention and are not therefore to be considered limiting of its scope, the invention will be described and explained with additional specificity and detail through the use of the accompanying drawings in which:

FIG. 1 illustrates an exemplary operating environment for embodiments of the present invention;

FIG. 2A is a block diagram that illustrates how an electronic document is generated, transmitted, recorded, and returned to a user;

FIG. 2B is a block diagram that illustrates exemplary components of an electronic document that has embedded digital signatures;

FIG. 3A is a block diagram illustrating an electronic document that has been recorded;

FIG. 3B is a block diagram that illustrates how the signature of the recorder is validated;

FIG. 3C is a block diagram that illustrates how the signature of the notary public is validated;

FIG. 3D is a block diagram that illustrates an electronic document that has been reconstructed for verification of a signature;

FIG. 3E is a block diagram that illustrates an electronic document that is in a signable state;

FIG. 4 is a block diagram illustrating multiple levels of validation for an electronic document;

FIG. 5 is a block diagram illustrating how an electronic document may be stored in a database;

FIG. 6 is a block diagram illustrating how an electronic document is processed when it is recorded;

FIG. 7 illustrates the relation of exemplary servers between which electronic documents may be moved, and also provides details concerning the arrangement of various elements of such exemplary servers;

FIG. 8A is a high level block diagram illustrating aspects of the relationship between and among various scripts employed in an embodiment of the invention, and indicating the general flow of a method suitable for moving an electronic document within a computer network;

FIG. 8B is a block diagram illustrating various aspects of a process employed within the context of an embodiment of a script for transferring electronic documents;

FIG. 8C is a block diagram illustrating various aspects of an embodiment of a process for receiving and validating electronic documents;

FIG. 8D is a block diagram illustrating various aspects of an embodiment of a process for handling validated electronic documents; and

FIG. 8E is a block diagram illustrating various aspects of an embodiment of a process for handling a processed electronic document.

### DETAILED DESCRIPTION OF VARIOUS EMBODIMENTS OF THE INVENTION

Embodiments of the invention may include computer-readable media for carrying or having computer-executable instructions or electronic content structures stored thereon. Such computer-readable media can be any available media which can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to carry or store desired program code in the form of computer-executable instructions or electronic content structures and which can be accessed by a general purpose or special purpose computer. When information is transferred or provided over a network or another communications connection (either hardwired, wireless, or a combination of hardwired or wireless) to a computer, the computer properly views the connection as a computer-readable medium. Thus, any such a connection is properly termed a computer-readable medium. Combinations of the above should also be included within the scope of computer-readable media. Computer-executable instructions comprise, for example, instructions and content which cause a general purpose computer, special purpose computer, or special purpose processing device to perform a certain function or group of functions.

The present invention is particularly well suited for use in conjunction with electronic document creation and validation systems such as may be used by county recorders and other personnel in effecting real property and other transactions. However, the features and advantages of embodiments of the present invention are useful in a variety of other applications as well.

Examples of other suitable environments for employment of embodiments of the present invention include, but are not limited to: (i) electronic courier services between governments and between attorneys; (ii) document management and claims management in the insurance industry; (iii) medical records creation, processing, and transfer; (iv) pharmacy records and processing; (v) government licensing functions in the areas of, for example, business licensing, professional licensing, vehicle licensing, and hunting, fishing, and firearms licensing; (vi) real estate and lending industries, such as for lines of credit and sight drafts; (vii) data publishing with certificate values; (viii) filings such as court, Securities and Exchange Commission filings, Uniform Commercial Code filings, liens, and Federal Aviation Administration filings; (viv) government statistics processing; and (x) applications where recorded documents are linked to record access applications.

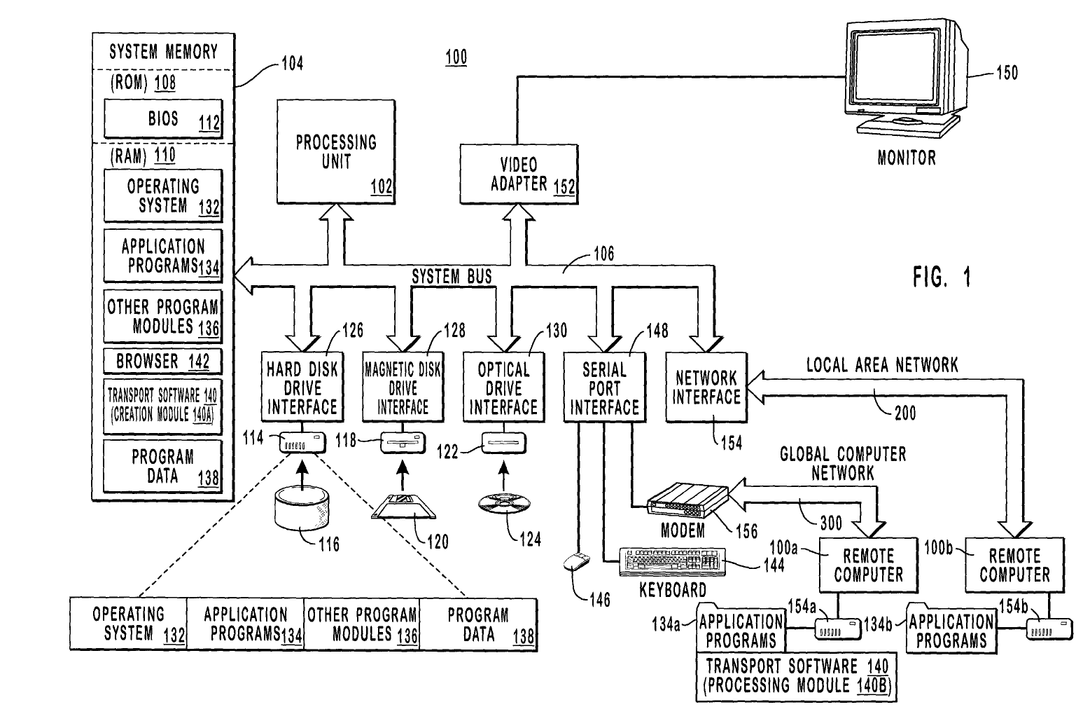

FIG. 1 and the following discussion are intended to provide a brief, general description of a suitable computing environment in which the invention may be implemented. Although not required, the invention will be described in the general context of computer-executable instructions, such as program modules being executed by computers in network environments. Generally, program modules include routines, programs, objects, components, scripts, content structures, etc. that perform particular tasks or implement particular abstract content types. Computer-executable instructions, associated content structures, and program modules represent examples of the program code for executing steps of the methods disclosed herein. The particular sequence of such executable instructions or associated content structures represent examples of corresponding acts for implementing the functions described in such steps.

The invention may be practiced in network computing environments with many types of computer system configurations, including personal computers, multi-processor systems, microprocessor-based or programmable consumer electronics, network PCs, minicomputers, mainframe computers, and the like. The invention may also be practiced in distributed computing environments where tasks are performed by local and remote processing devices that are linked (either by hardwired links, wireless links, or by a combination of hardwired or wireless links) through a communications network. In a distributed computing environment, for example, program modules may be located in both local and remote memory storage devices.

With reference to FIG. 1, an exemplary system for implementing the invention includes a general purpose computing device in the form of computer 100, including a processing unit 102, a system memory 104, and a system bus 106 that couples various system components including system memory 104 to processing unit 102. System bus 106 may be any of several types of bus structures including a memory bus or memory controller, a peripheral bus, and a local bus using any of a variety of bus architectures. System memory 104 includes read only memory (ROM) 108 and random access memory (RAM) 110. A basic input/output system (BIOS) 112, containing the basic routines that help transfer information between elements within client computer 100, such as during start-up, may be stored in ROM 108.

Computer 100 may also include a magnetic hard disk drive 114 for reading from and writing to a magnetic hard disk 116, a magnetic disk drive 118 for reading from or writing to a removable magnetic disk 120, and an optical disk drive 122 for reading from or writing to removable optical disk 124 such as a CD-ROM or other optical media. Magnetic hard disk drive 114, magnetic disk drive 118, and optical disk drive 122 are connected to system bus 106 by a hard disk drive interface 126, a magnetic disk drive interface 128, and an optical disk drive interface 130, respectively. The drives and their associated computer-Page readable media provide nonvolatile storage of computer-executable instructions, content structures, program modules and other content for client computer 100.

Although the exemplary environment described herein employs a magnetic hard disk 116, a removable magnetic disk 120 and a removable optical disk 124, other types of computer readable media for storing content can be used, including magnetic cassettes, flash memory cards, digital video disks, Bernoulli cartridges, RAMs, ROMs, and the like.

Program code comprising one or more program modules may be stored on hard disk 116, magnetic disk 120, optical disk 124, ROM 108 or RAM 110, and may take the form of, among other things, an operating system 132, one or more application programs 134, other program modules 136, program data 138, transport software 140 (comprising creation module 140A and processing module 140B, discussed below), and browser program 142. As discussed in further detail below, embodiments of transport software 140 are generally directed to providing for the secure transfer of electronic documents 900 (see FIG. 7) between servers in a computer network.

A user may enter commands and information into computer 100 through keyboard 144, pointing device 146, or other input devices (not shown), such as a microphone, joy stick, game pad, satellite dish, scanner, microphone, or the like. These and other input devices are often connected to processing unit 102 through a serial port interface 148 coupled to system bus 106. Alternatively, the input devices may be connected by other interfaces, such as a parallel port or a universal serial bus (USB) port. A monitor 150 or another display device is also connected to system bus 106 via an interface, such as video adapter 152. In addition to monitor 150, personal computers typically include other peripheral output devices (not shown), such as speakers, printers, scanners, and the like.

Computer 100 preferably operates in a networked environment using logical connections to one or more servers, such as servers 100A and 100B. Note that a ‘server’ may refer to a computer in a network shared by multiple users, and the term ‘server’ may also refer to both the hardware and/or software that performs one or more of the service(s), tasks, operations, and functions disclosed herein. Examples of types of different types of servers include, but are not limited to, web servers, application servers, remote access servers, mail servers, merchant servers, database servers, and the like. Further, servers 100A and 100B may each comprise another personal computer, a server, a router, a network PC, a peer device or other common network node, and typically includes many or all of the elements described above relative to computer 100, although only memory storage devices 154A and 154B and their associated application programs 134A and 134B have been illustrated in FIG. 1. Note that, in some applications, computer 100 may additionally, or alternatively, perform one or more functions of a server.

The logical connections depicted in FIG. 1 include a local area network (LAN) 200 and a global computer network 300 that are presented here by way of example and not limitation. Such networking environments are commonplace in office-wide or enterprise-wide computer networks, intranets and the Internet. Embodiments of the present invention may also be employed in the context of Wide Area Networks (WANs) and other networks that typically cover a wide geographic area such as a state or country.

When used in a LAN networking environment, computer 100 is connected to LAN 200 through a network interface 154. When used in a global computer network 300 networking environment, computer 100 may include a modem 156, a wireless link, or other devices for establishing communications over global computer network 300. Modem 156, which may be internal or external to computer 100, is connected to system bus 106 via serial port interface 148. In a networked environment, program modules depicted relative to computer 100, or portions thereof, may be stored in remote memory storage device(s) 154A and 154B. The network connections shown are exemplary and other methods of establishing communications over global computer network 300 may be used.

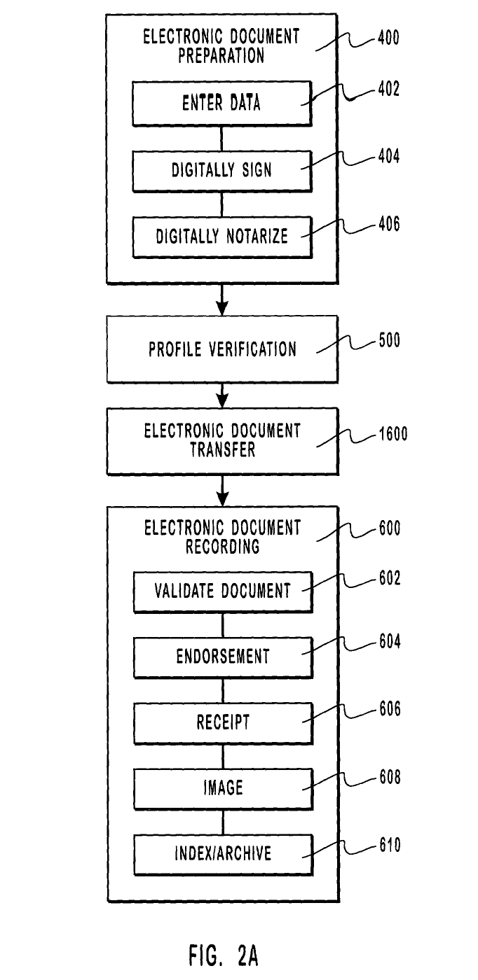

FIG. 2A is a block diagram that illustrates the preparation, transmission, and processing of an electronic document. The electronic document is first prepared and/or processed (400) such that the document may become a binding and legally enforceable document. Preparing and/or processing the electronic document may include entering data or content into a template (402), digitally signing the electronic document and/or digitally notarizing the document. Alternatively, a template is not necessary to prepare or create the electronic document and the electronic document can be created without a template.

After the content has been entered, the document is digitally signed (404) by one or more persons who are indicated in or on the electronic document. Signature blocks are provided in the document for each signer. The digital signatures of the document signers are inserted into corresponding signature blocks when the document is digitally signed by the signers. Alternatively, a signature block is added to the electronic document as each signer digitally signs the electronic document.

After all of the digital signatures have been obtained and inserted, the electronic document is digitally notarized (406). Digitally notarizing the electronic document is similar to digitally signing the electronic document, except that a notary signature block is used to store the necessary data and signature of the notary public. In some instances, the digital signature of the notary public is not necessary for an electronic document.

After the electronic document is prepared for verification, it undergoes an optional profile verification (500). The profile verification (500) is a module that determines whether recordation of the electronic document will be successful. For example, different counties often have different requirements for recording documents and it is possible to create an electronic document that is valid in one county but not another. The profile verification (500) is aware of validation instructions for various counties or jurisdictions and can usually determine whether the recordation of the electronic document will be successful. In this manner, potential problems can be remedied and rejection notices can be reduced or eliminated. The profile verification (500) can check the structure of the electronic document, the data type, the structure of the package, the data for specific jurisdictions, and the like.

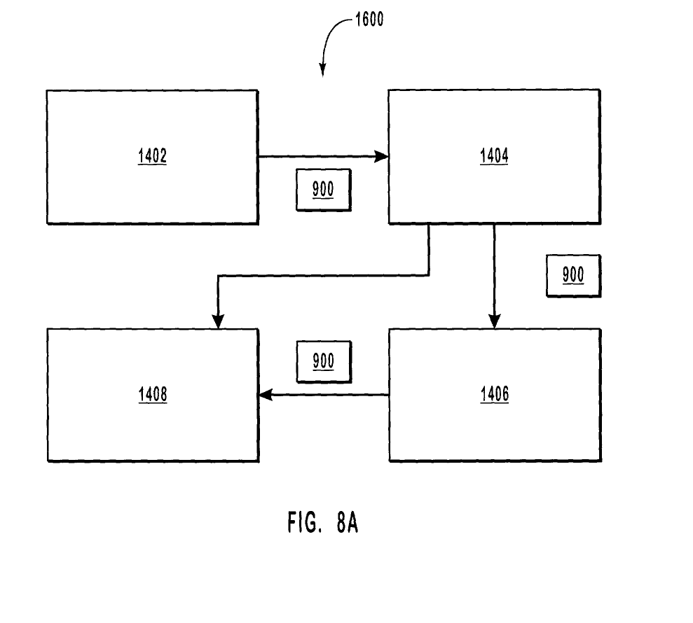

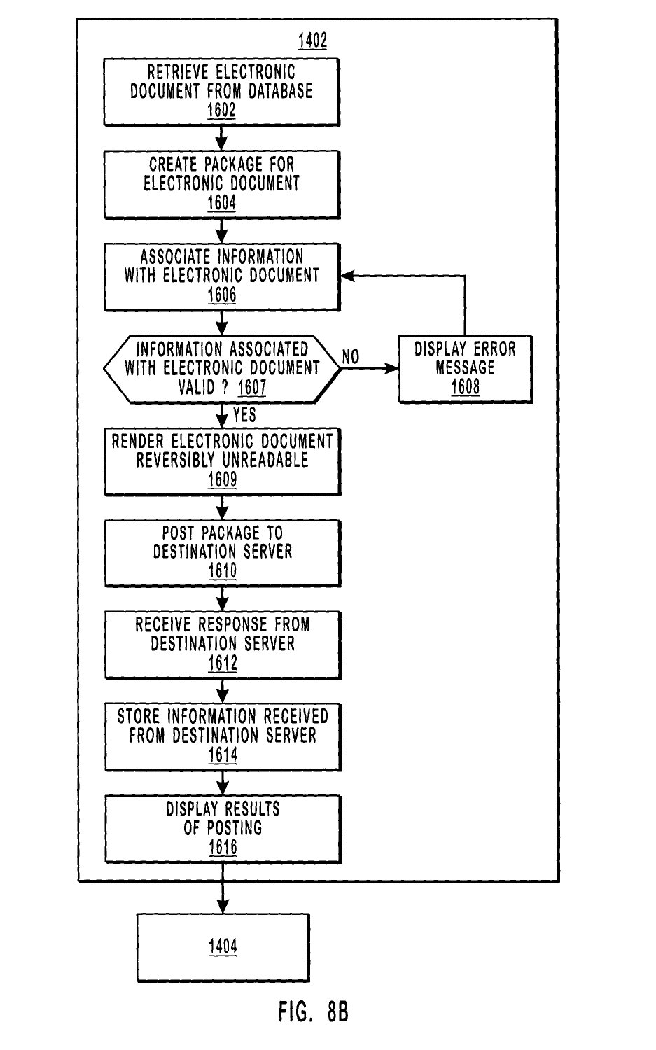

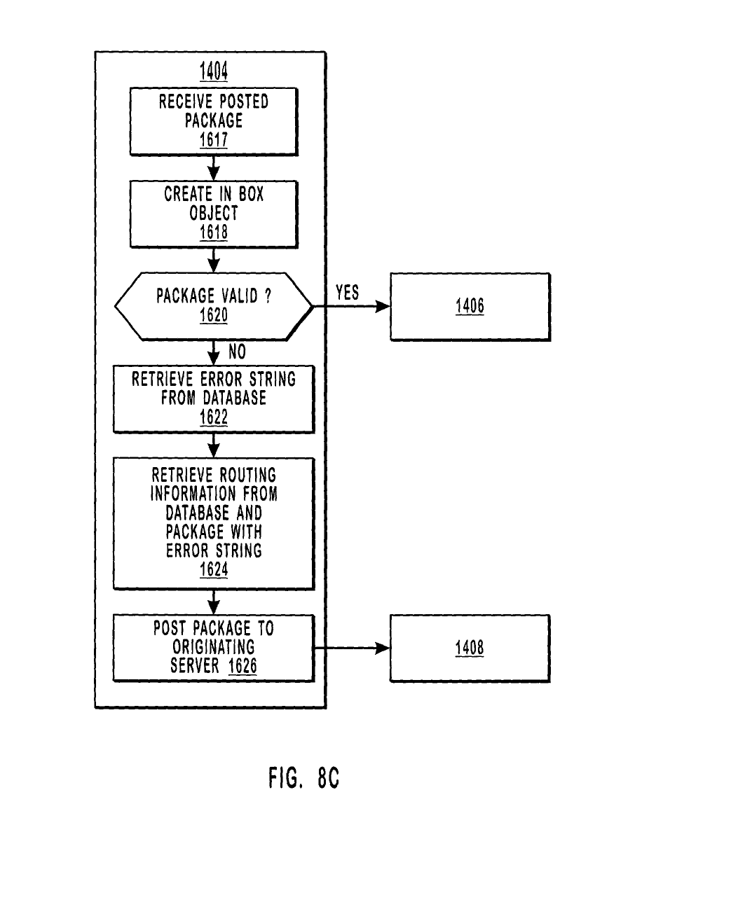

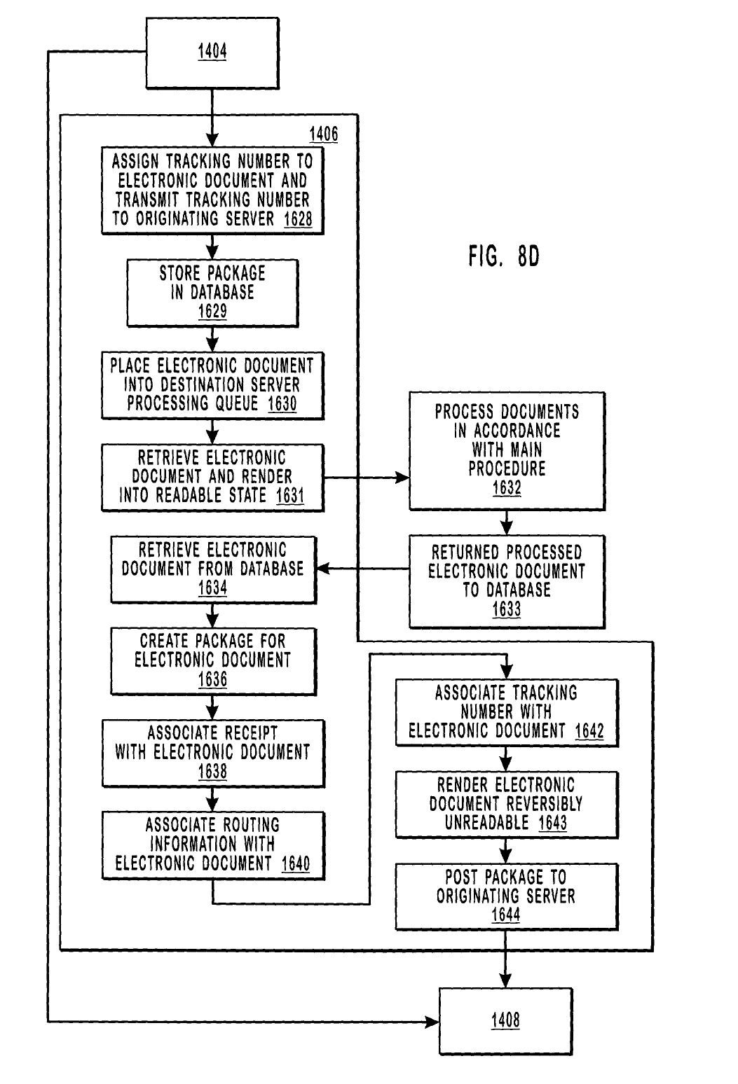

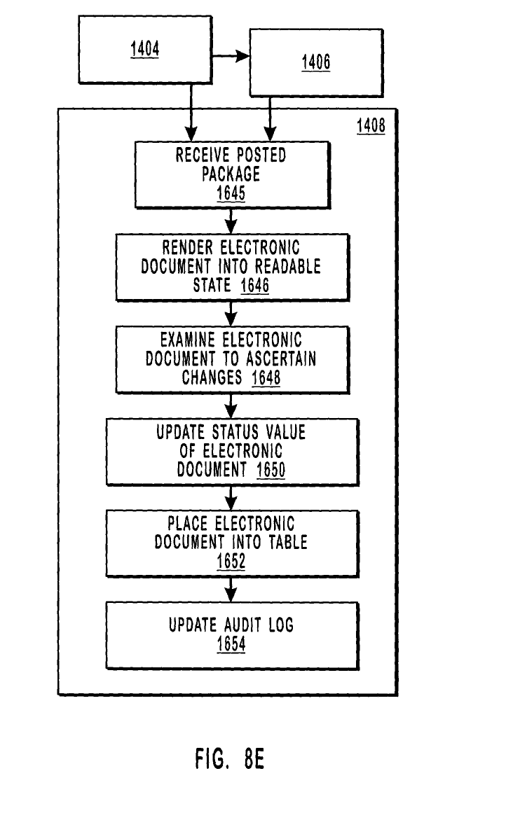

At this point, the digitally signed and notarized electronic document is submitted to and transmitted, using routing information in the electronic document, from an origination server or system to a destination server or system in accordance with a method 1600 for transferring electronic documents. Method 1600 also provides for returning the electronic document to the originating server after processing at the destination server. The details of method 1600 are presented below in the context of the discussion of FIGS. 7 through 8E.

Upon arrival at the destination server, the electronic document is processed or, more specifically in this example, recorded (600). Recording an electronic document begins by validating the electronic document (602). Validating the electronic document often includes reconstructing the electronic document to ensure that the document being recorded is the same document that was digitally signed by the signers and digitally signed by the notary public. Note that such validation is distinct from the “initial validation” step discussed elsewhere herein. Next, the recorder gives an endorsement (604) to the electronic document by populating an endorsement section of the electronic document. Endorsing the electronic document also requires that the recorder digitally sign the electronic document. The digital signature of the recorder is similar to the digital signatures of the signers and the notary public, but a recorder signature block is used.

After the electronic document has been endorsed, a receipt (606) is prepared for the electronic document. Next, the electronic document is imaged (608), then indexed and archived (610). Finally, the recorded electronic document along with the receipt is transferred, in accordance with method 1600, back to the origination server or system that was included in the routing information.

FIG. 2B is a block diagram that illustrates an exemplary electronic document 700. The electronic document 700 includes content 703. The content 703 typically relates to the purpose of the electronic document 700 and can be, but is not limited to, a contract between one or more parties, a real estate transaction, a security interest, a loan agreement and the like. The content 703 may also includes all information or data that is necessary for the document to be executed or signed or to have legal effect and may include, but is not limited to, information regarding the persons that will sign the electronic document, notary information, legal content regarding the transaction detailed in the content 703, terms, descriptions, expressions of intent, and the like.

The electronic document 700 passes through various states as it is created or generated. The document is in a signable state when all necessary information or content as described above is present in the electronic document 700. The document is in the notarizable state after the signers have digitally signed or executed the electronic document 700. The document progresses to the recordable state after it is verified that the document contains all necessary information and the digital signatures of the signers and the notary have been verified.

The electronic document 700 also includes routing information 701 and an endorsement 702. The routing information 701 identifies or stores the information that is needed to send and/or receive an electronic document. The routing information 701 may include, for example, an address of a receiving server, document identifiers, and other instructions that may be needed for processing. In addition to the routing information 701, other information may also be included in electronic document 700 including, but not limited to, the name of the sender, account information used to pay a fee, document and order identification, and an address of the sending server. In this manner, the origin and the destination of the electronic document 700 are known and can be tracked. Finally, as discussed in further detail in the context of FIGS. 7 through 8E, routing information 701 may take the form of uniform resource locators (“URL”).

The endorsement 702 contains, for example, tags or elements that have not been filled or populated. The endorsement 702 is usually reserved for the recorder (or similar entity) to populate upon recording or otherwise processing the electronic document. The endorsement 702 may reference identifying data including, but not limited to, a page, a date and time of recording; a county, a state, a fee, and entry number, a book identifier, a page identifier, the number of pages, the requesting party, the name of the recorder, and the like. The endorsement 702 is adapted to the situation and is in some situations omitted. For instance, some electronic documents are not recorded, but are simply signed. In this instance, the endorsement 702 may be reduced or eliminated.

The electronic document 700 also includes a signature display 704 and a notary display 705. Because the document 700 is an electronic document, the signature display 704 is able to display the signature of the signers in human readable form. Similarly, the notary display 705 is able to display the signature of the notary public such that it can be read on a display for example. The signature display 704 is often implemented using a <SignatureDisplay> tag that is initially empty. Upon signing or executing the document, the name of the signer is placed inside the <SignatureDisplay> tag and is often displayed in color. By displaying the names of the signers and the notary after they have digitally signed the document, a signer can more easily distinguish a signed document from an unsigned document. Similarly, the notary display 705 can also use the <SignatureDisplay> tag such that the name of the notary that notarized the document may be displayed as well.

The signature block 706 is used to contain the digital signature of the signer as well as other information. The notary block 707 and the recorder block 708 respectively contain the digital signatures of the notary public and the recorder, although these blocks can be adapted to the capacity of the person or entity signing a particular block. For example, the recorder block 708 may represent the signature of a bank official that authorizes a loan. In some instances, only signature blocks are needed on the electronic document 700 and a notary block and/or a recorder block are not necessary. The required signatures are often dependent on the transaction as well as on legal requirements. When a real estate transaction is recorded, both the notary block 707 and the recorder block 708 are usually required, although the required signatures may vary across jurisdictions.

More generally, the electronic document 700 is often implemented as a template where the signature blocks (including the notary signature block and the recorder signature block), the routing information 701, the endorsement 702, and other data is already present in the template. In this example, these elements only need to be populated by the recorder or other person/entity. This approximates a signature on a paper document, because the user only has to apply their digital signature to the electronic document in this example. In addition, the signature block is already part of the document and is not appended to the document for each signature. For example, when the template is selected, the user may be queried as to the number of signature blocks that are necessary. In this manner, the signature blocks for the persons that ultimately digitally sign the document are already present.

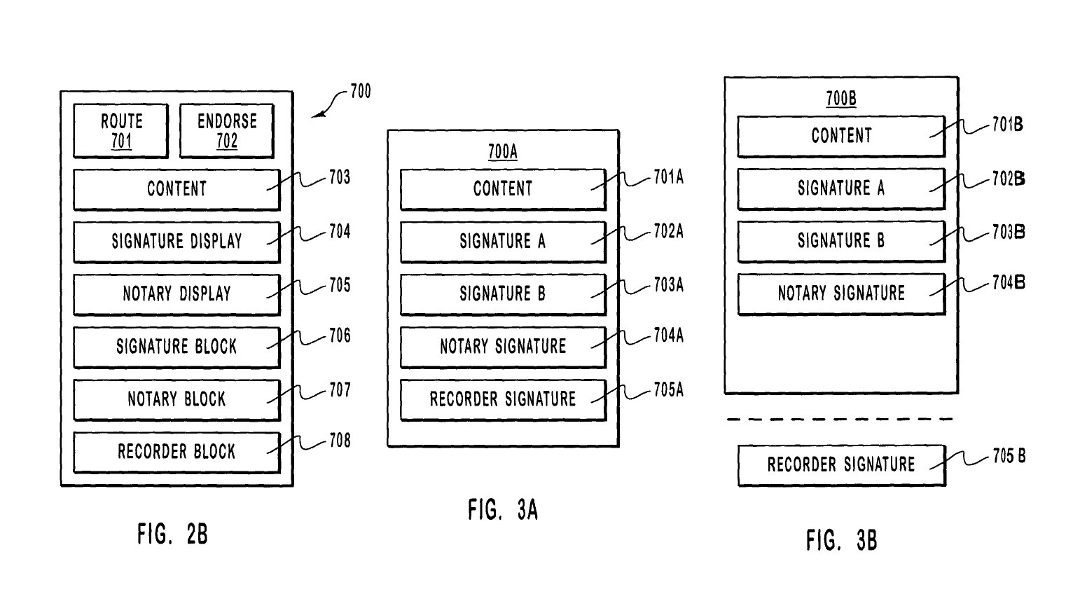

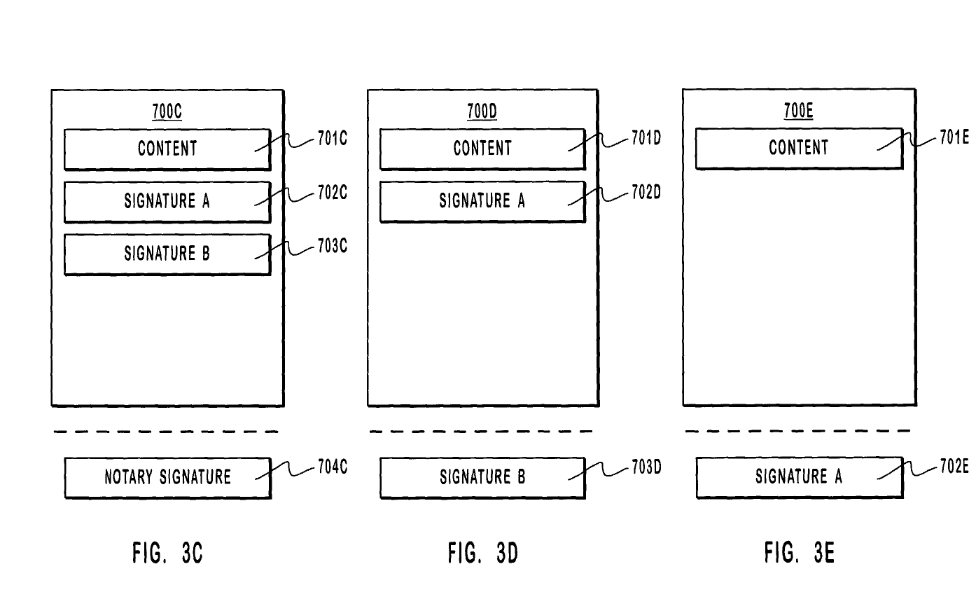

FIGS. 3A, 3B, 3C, 3D, and 3E are block diagrams that illustrate how an electronic document can be both reconstructed, verified, and/or validated. FIGS. 3A through 3E represent different states of the same electronic document, each of which can be reconstructed. FIG. 3A represents a recorded electronic document 700A after the electronic document has been verified and validated. FIG. 3B represents the electronic document 700B before it is recorded and the electronic document 700B has not been digitally signed by the recorder.

FIG. 3C represents the electronic document 700C before it is digitally signed by the notary public and the electronic document 700C does not have a digital notary signature. FIG. 3D represents an electronic document 700D that has only been signed by the signer A and does not have the digital signature 703D of signer B. Finally, FIG. 3E represents the electronic document 700E before it is digitally signed by the signer A. In FIG. 3D, the signature A 702D is embedded. In FIG. 3C, the signature A 702C and the signature B 703C are embedded. In FIG. 3B, the notary signature 704B is embedded in addition to the signature A 702B and the signature B 703B. In FIG. 3A, all necessary signatures, including the recorder signature 705A, are embedded in the electronic document 300.

FIGS. 3A through 3E thus illustrate an electronic document that has been signed in stages. The first or unsigned stage or state of the electronic document is represented by FIG. 3E and the final or fully signed state or stage of the document is represented by FIG. 3A. Any of the document stages represented by FIGS. 3A through 3E can be reconstructed from a later stage. For example, the electronic document 700D of FIG. 3D can be reconstructed from the electronic document 700C of FIG. 3C.

Reconstructing an electronic document ensures that the electronic document has not been changed or altered and is also used to when a digital signature is validated. For example, if a first signer digitally signs a document and emails that document to a second signer, the second signer desires some assurance that they are executing the same document executed by the first signer. This can be accomplished by reconstructing the electronic document to its previous state in this example.

In addition, each signer often desires a copy of what they digitally signed. This can be accomplished by emailing the document to the signer after it has been signed, by printing a signed version of the document, saving a copy of the document's current stage to a disk, and the like. This enables each signer to compare the document that is ultimately recorded with the document as it existed when they signed it.

FIG. 3B illustrates a completed electronic document 700B that has multiple digital signatures. In this example, the content 701B refers to a legal transaction that is to be recorded in a county office, although the content is not limited to a legal transaction as previously described. Signature A 702B is the digital signature of a first signer, signature B 703B is the digital signature of a second signer, notary signature 704B is the digital signature of a notary public (if necessary), and recorder signature 705B is the digital signature of a recorder.

As shown by FIGS. 3A through 3E, the first signature embedded in the electronic document was signature A 702/A/B/C/D/E (as applicable), which was followed by signature B 703/A/B/C/D/E (as applicable), notary signature 704/A/B/C/D/E (as applicable), and recorder signature 705/A/B/C/D/E (as applicable), respectively. Before the recorder digitally signs the electronic document 700A/B/C/D/E (as applicable) and places the recorder signature 705/A/B/C/D/E (as applicable) in the electronic document, the recorder will reconstruct the document to its previous stage or state, which is represented by FIG. 3B. Reconstructing the document allows the recorder to verify or validate the electronic document.

FIG. 3B thus illustrates a document that has been reconstructed to the state it was in before the recorder signed it. In a similar manner, FIG. 3C represents the electronic document before it was signed by the notary. FIG. 3D represents the electronic document before it was signed by signer B and FIG. 3E represents the electronic document before it was signed by signer A.

Each signature block, including the notary signature block and the recorder signature block, has a reconstruct attribute that describes what level or state the electronic document was in when it was digitally signed. A county recorder, for example, needs to be assured that the same document was signed by the signer A, the signer B, and the notary public before the digital signature of the recorder can be embedded in the electronic document. In some instances, it may be necessary to reconstruct the document to more than one state or level for validation purposes. An exemplary signature block is as follows:

<SignatureBlock reconstruct=“1”>

<Signature hashalgorithm=“MD5” datetime=“5/17/01 1:56:33 PM” signemame=“Jim Smith” signertitle=“Grantor” base64value=“eUWEy6Ln . . . +HGIZkduvqc”/>

<Certificate base64value=“axkE6 . . . 0kvB4oeBylCA”/>

</SignatureBlock>

The <SignatureBlock>element has, but is not limited to, a reconstruct attribute. The reconstruct attribute is used when the electronic document is reconstructed and is also used to determine the order in which the signers signed or executed the electronic document.

The above example of a signature block includes a <Signature> element and a <Certificate> element. The <Signature> element has attributes that include, but are not limited to, hashalgorithm, datetime, signemame, signertitle, and base64value. The hashalgorithm attribute identifies a particular hash algorithm and the timedate attribute identifies when the electronic document was signed or executed by time and date. The signername attribute identifies the name of the person or entity signing the electronic document while the signertitle attribute identifies the title of the person or entity signing or executing the electronic document. The base64value attribute corresponds to the digital signature of the signer. The <Certificate> element includes, but is not limited to, a base64value attribute that corresponds to a digital certificate of the signer.

The information that is included in the <SignatureBlock> ensures that the electronic document has not changed since it was signed or executed by the previous signer and enables the electronic document to be reconstructed for validation purposes. Signing an electronic document necessarily changes the document and those that execute or sign the electronic document at a later time need assurance that the original document has not altered or has not been changed. This can be accomplished through the signature block.

When the recorder applies the recorder signature 700A to the electronic document as shown in FIG. 3A, some of attributes in the recorder signature block are filled before the base64value attribute, which is the digital signature of the recorder, is generated. More specifically, the signername attribute, the datetime attribute, and the signertitle attribute are filled when the recorder digitally signs the electronic document. As a result, these attributes will be included in the hash of the electronic document that is encrypted by the private key of the recorder. Alternatively, these fields are not filled when the digital signature is generated and as a result, these field values are not included in the hash value generated from the electronic document.

When an electronic document is verified or validated, it is first reconstructed using the reconstruct attribute and it is necessary to reconstruct the document to its previous state before it is validated or verified. Reconstructing a document is usually performed in memory with a copy of the electronic document and the original electronic document is not altered during reconstruction. The following example, with reference to FIGS. 3A and 3B, illustrates how the electronic document is reconstructed and how the recorder's signature is validated or verified. A similar process can be applied to validate and/or reconstruct other levels or stages of the electronic document. To reconstruct the document to the state it was in before the signature of the recorder was embedded in the electronic document, all information added by the recorder needs to be removed from the electronic document. This can be determined in part from the reconstruct attribute.

The reconstruct attribute of the signature block of the recorder is usually different, often larger, than the reconstruct attributes of the other signature blocks. In this example, the endorsement data, and the base64value attribute in the recorder's signature block are stripped from the document in order to reconstruct the electronic document to a previous state. No data is stripped from the other signature blocks because they have a lower or different reconstruct attribute. After the document has been reconstructed in this manner, the resulting document can be hashed using the hashalgorithm that is identified in the signature block of the recorder. The digital signature of the recorder is decrypted using the public key of the recorder that is in the digital certificate included in the <certificate> tag of the signature block. Alternatively, the certificate could be implemented as an attribute of the <signature> element. If the hash of the reconstructed document matches the decrypted digital signature, then the electronic document and the recorder's signature are validated. In the case where the other attributes were added to the signature block after the digital signature of the recorder was generated, then these values will also be stripped from the document during reconstruction of the electronic document.

The signature of the notary, with reference to FIGS. 3B and 3C can be similarly validated and verified. Using the reconstruct attribute of the notary signature block, it is possible to strip out the relevant notary data such that the resulting document is reconstructed to its previous state. If the recorder has also digitally signed the document, it is necessary to strip out the data input by the recorder in order to reconstruct the document such that the signature of the notary public can be validated or verified. After the document has been reconstructed, the resulting electronic document is hashed and the hash value is compared to the decrypted digital signature of the notary. If the values match, then the document and the notary signature are validated.

In another case, it is possible for one or more signatures to have the same reconstruct attribute. The value of the reconstruct attribute can be equal to the reconstruct attribute of another signature when a signer does not want to incorporate the signature of another signer in their digital signature. In this case, reconstruction of the document requires that the affected data of both signers be stripped in order to reconstruct the document to its previous state.

More generally, reconstructing and verifying or validating an electronic document requires that that information be stripped from the electronic document. The information that is to be removed or stripped from the document can be identified from the reconstruct attribute. In the case of validating the signature of the recorder shown in FIG. 3A, reconstruction results in the electronic document 700B shown in FIG. 3B, where the recorder signature and endorsement data has been stripped or removed from the electronic document 700A. In this manner, the signatures can be verified or validated.

Another example of a signature block or signature element is as follows:

<Signature SigID=“1” Name=“Joe J Recorder” certificate =“axxy6 . . . 0kvB4oeBylCA” hashAIg=“MD5” Signature=“axkE60 . . . kvB4oeBylCA” “timestamp=“date time”>==Joe J Recorder==</Signature>

In this example of a signature block or signature element, all of the associated data is in an attribute. Exemplary attributes include a signature identifier (SigID) a name attribute that stores the name of the signer, a certificate attribute that carries a digital certificate of the signer, a signature attribute that stores the digital signature of the signer, a timestamp attribute that identifies when the electronic document was digitally signed, and the name of the signer in text that results in the name of the signer being displayed where the digital signature is embedded.

When an electronic document is signed using this example, some of the attributes are populated or filled just before the digital signature of the signer is generated. Usually, all of the attributes are filled before the digital signature is generated. Thus the digital signature is related to all of the data in the electronic document except the digital signature of the signer. When the document is reconstructed, it is only necessary to remove the digital signature of the signer. In addition, each signature block or signature element is added to the document when the document is digitally signed. Thus, the signature block for the notary and/or the recorder are not yet present in the electronic document when signed by a primary signer. Alternatively, it is possible to have the signature blocks for the notary and/or the recorder in the document, but they are not yet populated because the notary and the recorder have not yet digitally signed the electronic document.

Reconstructing an electronic document in this case uses the identity of the signer. If the digital signature of the recorder is being validated or verified, it is only necessary to strip or remove the digital signature of the recorder in order to reconstruct the electronic document. If the digital signature of the notary is being reconstructed, it is necessary to remove or strip out the digital signature of the notary as well as the signature block or signature element of the recorder in order to reconstruct the electronic document to a previous state. This is possible because it is known that the recorder digitally signs the document after the notary. In a similar manner, it is clear that the notary digitally signs the electronic document after the primary signer. Thus, verification or validation of the primary signer requires the signature block or signature element of both the recorder and the notary to be removed from the electronic document during reconstruction. The digital signature of the primary signer is also removed during reconstruction of the document for verification of the primary signer. Thus, a reconstruct attribute is not necessary in this example and is therefore not included in this example of the signature block.

As each signer digitally signs the document, the name of the signer will appear in the electronic document because of the text portion of the signature block or signature element. In this example, the <SignatureDisplay> tag is not necessary.

Extensible Markup Language (XML) allows elements to be self defined and the present invention includes Electronic Recording Markup Language (ERML), which is an example of a collection of elements that can be used with electronic documents. XML (and ERML by extension) is primarily concerned with data and data structure and is not primarily concerned with data presentation. XHTML, however, provides a standard set of tags that is used to make data visually appealing. The present invention combines XML or ERML and XHTML to provide a portable data structure that is visually appealing. In other words, the XML or ERML described herein is part of a schema that has a Document Type Definition (DTD). The advantage of combining XML and XHTML is that a document is generated that is human readable as well as machine readable. This enables electronic documents to be rendered on a computer such that they can be read by a person and understood by the computer. The combination of XML and/or ERML and XHTML preserves the monolithic nature of the electronic document such that a signer is signing the electronic document. This is different from other applications, where the signer is unsure of whether they are signing the style sheet than rendered an XML document or whether they are signing an XML document in good faith.

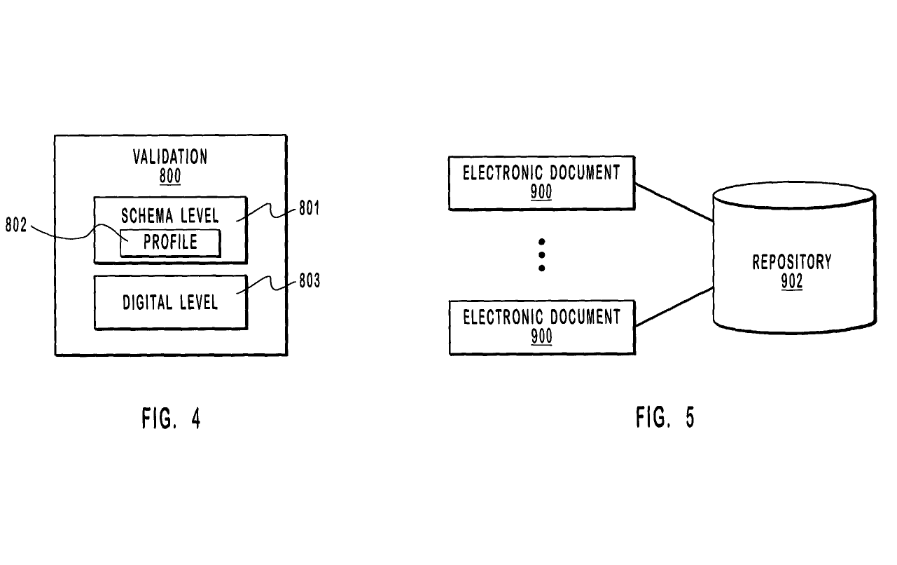

FIG. 4 is a block diagram that illustrates a broad view of how an electronic document is validated or verified. Validation 800 occurs on at least two levels. The schema level 801 is used to validate the format or structure of the electronic document. The digital level 803 includes digital signatures and digital certificates as previously described. The XML or ERML schema should define every element and attribute within a particular document in order for that document to be valid. Each tag or element in an electronic document is checked to ensure that they conform with the specified schema and an electronic document is considered valid when it conforms to standards that are imposed by the relevant schema. A schema check thus ensures that the tags or elements included in the electronic document occur in their proper or defined order and that all of the required tags and elements are present. The content of each element or tag is also checked against the element data type defined by the schema.

A profile 802 is also associated with the schema level 801. In a profile check, the document is processed to determine if the electronic document has the elements, tags and attributes that are necessary for a particular purpose, such as recording a document. A profile check differs from a schema check in that the profile check does not check for correct data type content, but only checks for the existence of defined tags or elements and their attributes. The schema level 801 type of validation usually occurs before the digital level 803 validation. If an electronic document is invalid on its face, then it cannot be properly processed even if the digital signatures are valid and verifiable.

FIG. 5 is a block diagram that describes one example of how electronic documents are stored. Electronic documents (represented by electronic documents 900) can be stored as text in a file or as text files. In this example, however, the electronic documents 900 are stored in a database or repository 902, which provides several advantages. By storing the electronic documents in a repository or a database, they are protected from alteration or deletion while they are stored. Encryption can also be utilized for privacy and protection. In addition, storing the electronic documents in a database facilitates searching. Searching is further facilitated because the electronic documents described herein are delimited by XML elements. The electronic documents can be sorted, filtered, searched and the like.

Note that electronic documents 900 are not limited to electronic documents of particular states or statuses. Rather, electronic documents 900 generally include any and all of the electronic documents disclosed herein. Specifically, electronic documents 900 include electronic documents 700A through 700E.

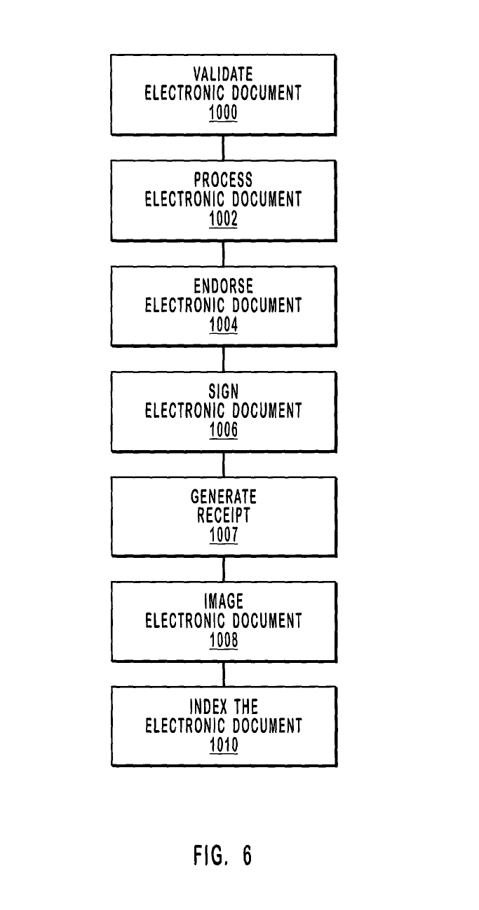

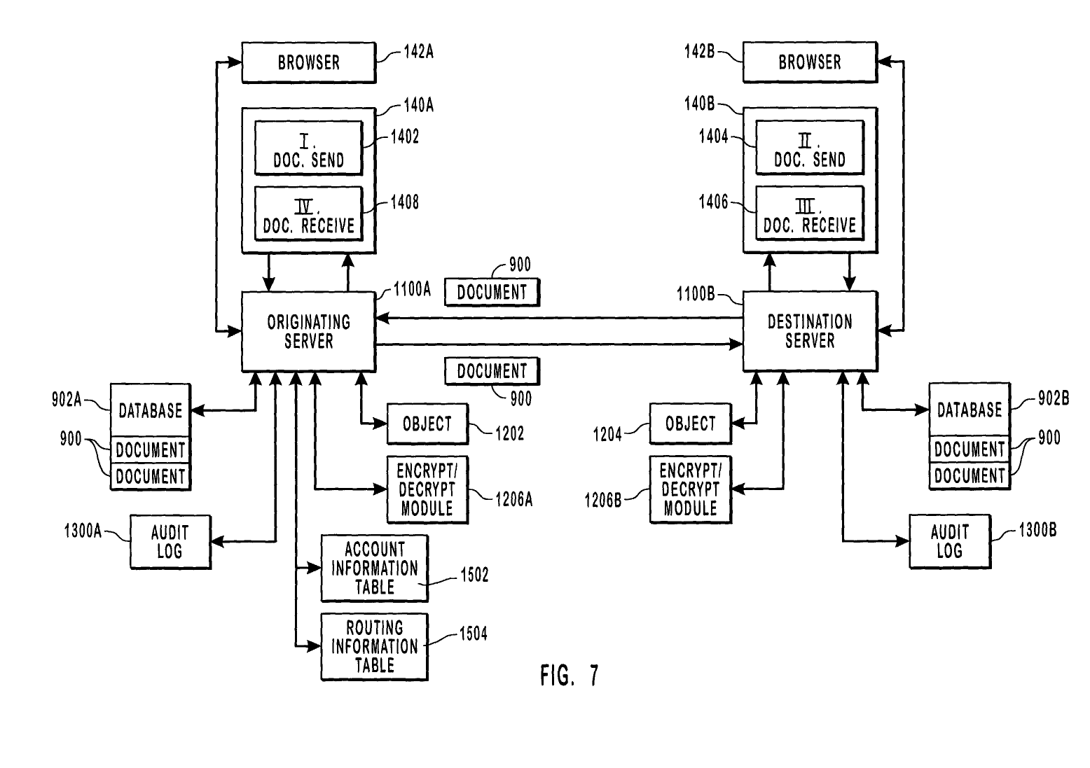

FIG. 6 is a block diagram that illustrates how an electronic document is processed. More specifically, FIG. 6 illustrates how an electronic document is recorded. When the electronic document is received, it is subjected to an initial validation (1000). The validation or verification of the electronic document can be performed on different levels and different aspects of the electronic document. The electronic document is often checked to insure that it has a valid format (xHTML). A profile and/or schema check may also be performed as previously described. Because the electronic document can be embodied in different types, a check is made to ensure that the electronic document is of a type that is accepted by the recorder. Additional types of validation schemes are discussed below in the context of the method 1600 for transferring electronic documents.

The validity of the data contained in the electronic document is checked to insure that it is within proper ranges, for example. In some instances, the electronic document is required to have certain tags, and the document is checked to determine if these tags are present. Finally, the notary signature is validated as previously described. This can involve reconstructing the document to a previous state as previously described.

Next, the electronic document is processed (1002). In this example, the number of pages in the electronic document is determined. This can be accomplished by imaging the electronic document for the purpose of counting the number of pages. The appropriate fee is then computed, based on both the document and/or the number of pages. If possible, funds are transferred to pay the fee.

After the fee has been paid, the electronic document is endorsed (1004). This includes the act of inserting the endorsement data into the empty fields of the electronic document that are already present. The endorsement data may include, for example, the book, page, and entry number of the recorded document, the cost of recording the electronic document, a timestamp, the count and state of recordation, the name of the county official, and the county official's digital signature. The endorsement is applied to the electronic document in this manner.

After the endorsement data is applied or inserted in the document, the electronic document is digitally signed by the recorder (1006) as previously described. Next, a receipt is generated (1007) that reflects the recordation of the electronic document. Then, the electronic document is imaged (1008) again for archival purposes.

The electronic document is then indexed (1010). The electronic document is an XML (or ERML) document, and the data from the elements can be extracted and stored or indexed. The indexed documents can be searched more easily and the further validation can be performed on the recorded data if necessary.

Often, electronic documents are not sent one at a time but in groups. The present invention provides XML or ERML elements that permit the separate documents to be easily recognized and processed. The actions taken during processing a group of electronic documents, however, can vary. For example, if one of the documents is not validated, then the entire group may be rejected and not processed or recorded. Alternatively, only the electronic document that was not validated may be rejected and not recorded. In some instances, the XML can include processing messages that define how to handle an electronic document that is not validated.

The following is a document type definition (DTD) for the XML elements used in conjunction with the present invention. The present invention, however, is not limited to the following DTD.

<?xml version=‘1.0’ encoding=‘UTF-8’?>

<!--Generated by XML Authority-->

<!ELEMENT erml:Document (#PCDATA|erml:EndorsementArea|erml:Return|erml:InstrumentType|erml:R|erml:E|erml:LegalDescBlock|erml:ParcelNo|erml:CrossReferencedInfo|erml:Date|erml:Other|erml:SigArea|erml:WitnessInfo|erml:NotaryArea)*>

<!ATTLIST erml:Document Version CDATA #REQUIRED

Type (Document|RejectionNotice|Receipt) #REQUIRED>

<!--Reserved for the Recorder use. Inserts endorsement information here. See Outbound_Endorsed.DTD-->

<!ELEMENT erml:EndorsementArea EMPTY>

<!ATTLIST erml:EndorsementArea EndorseId CDATA #IMPLIED>

<!--Submitted at request of information-->

<!ELEMENT erml:Return (erml:Name, erml:StreetAddress1, erml:StreetAddress2, erml:City, erml:State, erml:Zip, erml:Email?)+>

<!--Document Title (ie. Deed of Reconveyance, Deed of Trust, etc-->

<!ELEMENT erml:InstrumentType (#PCDATA)>

<!ATTLIST erml:InstrumentType Code CDATA #REQUIRED

e-dtype NMTOKEN #FIXED ‘string’>

<!--Contains information about the signing party of the document (ie.grantor, trustor)-->

<!ELEMENT erml:R (erml:FirstName, erml:MiddleName, erml:LastName, erml: Suffix, erml:Title)>

<!ATTLIST erml:R Type (Document|RejectionNotice|Receipt) #REQUIRED>

<!--Contains information about the beneficiary of the document (ie.grantee, trustee)-->

<!ELEMENT erml:E (erml:FirstName, erml:MiddleName, erml:LastName, erml:Suffix, erml:Title)>

<!ATTLIST erml:E Type (Document|RejectionNotice|Receipt) #REQUIRED>

<!--Legal Desciption information-->

<!ELEMENT erml:LegalDescBlock (#PCDATA|erml:Lot|erml:Block|erml:Plat erml:Subdivision|erml:Township|erml:Range″erml:Section|erml:QtrSection|erml:QtrQtrSection|erml:Meridian|erml:LegalDesc)*>

<!--Assessors Number or sidwell number-->

<!ELEMENT erml:ParcelNo (#PCDATA)>

<!ATTLIST erml:ParcelNo e-dtype NMTOKEN #FIXED ‘string’>

<!--References information from another document-->

<!ELEMENT erml:CrossReferencedlnfo (erml:Date erml:Book|erml:Page|erml:InstrumentNo|erml:County|erml:State)*>

<!ELEMENT erml:Book (#PCDATA)>

<!ATTLIST erml:Book e-dtype NMTOKEN #FIXED ‘int’>

<!ELEMENT erml:Page (#PCDATA)>

<!ATTLIST erml:Page e-dtype NMTOKEN #FIXED ‘int’>

<!ELEMENT erml:InstrumentNo (#PCDATA)>

<!ATTLIST erml:InstrumentNo e-dtype NMTOKEN #FIXED ‘int’>

<!ELEMENT erml:County (#PCDATA)>

<!ATTLIST erml:County e-dtype NMTOKEN #FIXED ‘string’>

<!ELEMENT erml:Date (#PCDATA)>

<!ATTLIST erml:Date DateType (Execution|Recorded|Payoff|Expiration)

#REQUIRED

e-dtype NMTOKEN #FIXED ‘date’>

<!ELEMENT erml:Other (#PCDATA)>

<!ATTLIST erml:Other e-dtype NMTOKEN #FIXED ‘string’>

<!ELEMENT erml:SigArea (erml:Company, erml:Signature, erml:Name, erml:Title)>

<!ELEMENT erml:WitnessInfo (#PCDATA|erml:Date|erml:County|erml:State|erml:Name|erml:Title)*>

<!--Notary signing area-->

<!ELEMENT erml:NotaryArea (erml:Name, erml:NotarySignature, erml:Date, erml:Residence)>

<!ELEMENT erml:Company (#PCDATA)>

<!ATTLIST erml:Company e-dtype NMTOKEN #FIXED ‘string’>

<!ELEMENT erml:Name (#PCDATA)>

<!ATTLIST erml:Name e-dtype NMTOKEN #FIXED ‘string’>

<!ELEMENT erml:StreetAddress1 (#PCDATA)>

<!ATTLIST erml:StreetAddress1 e-dtype NMTOKEN #FIXED ‘string’>

<!ELEMENT erml:StreetAddress2 (#PCDATA)>

<!ATTLIST erml:StreetAddress2 e-dtype NMTOKEN #FIXED ‘string’>

<!ELEMENT erml:City (#PCDATA)>

<!ATTLIST ennl:City e-dtype NMTOKEN #FIXED ‘string’>

<!ELEMENT erml:State (#PCDATA)>

<!ATTLIST erml:State e-dtype NMTOKEN #FIXED ‘string’>

<!ELEMENT erml:Zip (#PCDATA)>

<!ATTLIST erml:Zip e-dtype NMTOKEN #FIXED ‘string’>

<!ELEMENT erml:Email (#PCDATA)>

<!ATTLIST erml:Email e-dtype NMTOKEN #FIXED ‘uri’>

<!ELEMENT ernl:FirstName (#PCDATA)>

<!ATTLIST erml:FirstName e-dtype NMTOKEN #FIXED ‘string’>

<!ELEMENT ennl:LastName (#PCDATA)>

<!ATTLISTennl:LastName e-dtype NMTOKEN #FIXED ‘string’>

<!ELEMENT erml:Lot (#PCDATA)>

<!ATTLIST erml:Lot e-dtype NMTOKEN #FIXED ‘string’>

<!ELEMENT erml:Subdivision (#PCDATA)>

<!ATTLIST erml:Subdivision e-dtype NMTOKEN #FIXED ‘string’>

<!ELEMENT erml:Township (#PCDATA)>

<!ATTLIST erml:Township e-dtype NMTOKEN #FIXED ‘string’>

<!ELEMENT erml:Range (#PCDATA)>

<!ATTLIST erml:Range e-dtype NMTOKEN #FIXED ‘string’>

<!ELEMENT erml:Section (#PCDATA)>

<!ATTLIST erml:Section e-dtype NMTOKEN #FIXED ‘string’>

<!ELEMENT erml:QtrSection (#PCDATA)>

<!ATTLIST erml:QtrSection e-dtype NMTOKEN #FIXED ‘string’>

<!ELEMENT erml:QtrQtrSection (#PCDATA)>

<!ATTLIST erml:QtrQtrSection e-dtype NMTOKEN #FIXED ‘string’>

<!ELEMENT erml:Meridian (#PCDATA)>

<!ATTLIST erml:Meridian e-dtype NMTOKEN #FIXED ‘string’>

<!ELEMENT erml:LegalDesc (#PCDATA)>

<!ATTLIST erml:LegalDesc e-dtype NMTOKEN #FIXED ‘string’>

<!ELEMENT erml:Signature (#PCDATA)>

<!ATTLIST erml:Signature e-dtype NMTOKEN #FIXED ‘string’>

<!ELEMENT erml:NotarySignature (#PCDATA)>

<!ATTLIST erml:NotarySignature e-dtype NMTOKEN #FIXED ‘string’>

<!ELEMENT erml:Residence (#PCDATA)>

<!ATTLIST erml:Residence e-dtype NMTOKEN #FIXED ‘string’>

<!ELEMENT erml:MiddleName (#PCDATA)>

<!ATTLIST erml:MiddleName e-dtype NMTOKEN #FIXED ‘string’>

<!ELEMENT erml:Suffix (#PCDATA)>

<!ATTLIST erml:Suffix e-dtype NMTOKEN #FIXED ‘string’>

<!ELEMENT erml:Title (#PCDATA)>

<!ATTLIST erml:Title e-dtype NMTOKEN #FIXED ‘string’>

<!ELEMENT erml:Block (#PCDATA)>

<!ATTLIST erml:Block e-dtype NMTOKEN #FIXED ‘string’>

<!ELEMENT erml:Plat (#PCDATA)>

<!ATTLIST erml:Plat e-dtype NMTOKEN #FIXED ‘string’>

The following is another document type definition (DTD) for the XML elements used in conjunction with the present invention. The following DTD is particularly useful with a package of electronic documents. The present invention, however, is not limited to the following DTD.

<?xml version=‘1.0’ encoding=‘UTF-8’?>

<!--Generated by XML Authority-->

<!ELEMENT erml:Package (erml:RoutingBlock, erml:Documents, erml:Payment)>

<!ELEMENT erml:RoutingBlock (erml:RouteTo, erml:RouteFrom)>

<!ELEMENT erml:Documents (erml:DocumentContainer)>

<!ATTLIST erml:Documents DocCount CDATA #IMPLIED>

<!ELEMENT erml:Payment (erml:Debit erml:Credit erml:eCheck)>

<!ELEMENT erml:RouteTo EMPTY>

<!ATTLIST erml:RouteTo Account CDATA #IMPLIED

URL CDATA #IMPLIED

Org CDATA #IMPLIED>

<!ELEMENT erml:RouteFrom EMPTY>

<!ATTLIST erml:RouteFrom Account CDATA #IMPLIED

URL CDATA #IMPLIED

Org CDATA #IMPLIED>

<!ELEMENT erml:DocumentContainer (erml:Identification)>

<!ATTLIST erml:DocumentContainer DocID CDATA #IMPLIED

DocCode CDATA #IMPLIED >

<!ELEMENT erml:Debit EMPTY>

<!ELEMENT erml:Credit EMPTY>

<!ELEMENT erml:eCheck EMPTY>

<!ELEMENT erml:Identification (erml:To, erml:From)>

<!ELEMENT erml:To EMPTY>

<!ATTLIST erml:To Account CDATA #IMPLIED

TrackingNumber CDATA #IMPLIED

RefID CDATA #IMPLIED>

<!ELEMENT erml:From EMPTY>

<!ATTLIST erml:From Account CDATA #IMPLIED

TrackingNumber CDATA #IMPLIED RefID CDATA #IMPLIED>

Directing attention now to FIGS. 7 through 8E, specific details are provided regarding various aspects of processes, methods, and software for transporting the electronic documents between the originating server and the destination server.

In the illustrated embodiment, methods and processes encompassed by transport software 140 are employed in the context of a global computer network 300 that includes servers 1100A and 1100B. For the purposes of this discussion, server 1100A is designated the “originating server” and server 1100B is designated the “destination server.” As described above, electronic documents are constructed at originating server 1100A and then transmitted to destination server 1100B for processing.

Note that the aforementioned server designations are made simply to facilitate discussion of the illustrated embodiment and are not intended to limit the scope of the invention in any way. As discussed below, for example, originating server 1100A also serves as a destination for electronic documents transmitted from destination server 1100B serve to process electronic documents in addition to facilitating their creation.

Finally, embodiments of the invention are not limited solely to an originating server 1100A and a destination server 1100B. Rather, the functions performed by, or by way of, originating server 1100A and a destination server 1100B may be apportioned among additional or alternative servers.

In at least one embodiment of the invention, originating server 1100A and destination server 1100B each comprise a web server. As noted elsewhere herein however, such as in the discussion of FIG. 1, originating server 1100A and destination server 1100B may assume other configurations as well. For example, within the context of a local area network 200, such as an intranet, originating server 1100A and destination server 1100B may comprise intranet servers. In yet another embodiment of the invention, electronic documents 900 are transferred between an originating database and a destination database.

In the illustrated embodiment, originating server 1100A and destination server 1100B are each associated with a database, 902A and 902B respectively, wherein one or more electronic documents 900 may be stored, and from which electronic documents 900 may be retrieved. As used herein, an electronic document refers to any document within which one or more digital signatures may be removably embedded and which is configured to permit digital validation of one or more of such digital signatures. Such electronic documents 900 may comprise any of a variety of different types including, but not limited to, electronic documents such as may be employed in effecting real property transactions.

Databases 902A and/or 902B may each comprise a subcomponent of the respective servers with which they are associated. For example, database 902A and/or 902B may be stored in the system memory (not shown) of originating server 1100A and destination server 1100B, respectively. Alternatively, one or both of databases 902A and 902B may be located remotely from their respective servers, but accessible thereby.

In addition to respective databases 902A and 902B, originating server 1100A and destination server 1100B are each associated with respective browser programs 142A and 142B. Such browser programs 142A and 142B are in operative communication with, respectively, originating server 1100A and destination server 1100B. As in the case of databases 902A and 902B, browser programs 142A and 142B may be located locally at the respective server, or may alternatively be located remotely therefrom.

In general, the actions of originating server 1100A and destination server 1100B with respect to the transfer of electronic documents 900 between such servers are performed in accordance with user input provided to originating server 1100A and destination server 1100B by way of browser 142A and 142B, respectively. Such input causes the corresponding server to perform one or more operations consistent with web server instructions embodied in transport software 140.

In the illustrated embodiment, transport software 140 comprises web server instructions in the form of a creation module 140A, associated with originating server 1100A, and a processing module 140B, associated with destination server 1100B. Such web server instructions may be stored locally at the server with which they are associated, or may alternatively be stored in a remote location from which they can direct the operations of the associated server.

In at least some embodiments of the invention, transport software 140 comprises at least two types of “web server instructions” to carry out various processes relating to electronic document(s) 900. In particular, at least some embodiments of the invention include both predefined uncompiled programming modules, or “scripts,” as well as “objects” such as, but not limited to, compiled Dynamic Link Libraries (“DLL”).

Scripts, for example, may be created in a variety of different formats, consistent with the requirements of a particular application. Examples of script formats include, but are not limited to, active server page (“ASP”) scripts, common gateway interfaces (“CGI”), Java, and Javascript. Further, a given script, or “main” script, may include other, “subordinate,” scripts called from within the main script to perform particular functions. In general, the structuring of the main script and/or subordinate scripts may be designed as necessary to suit a particular application.

Typically, a user may cause originating server 1100A, for example, to perform the instructions contained in an ASP script entitled “homepage.asp” by entering the uniform resource locator (“URL”) http://www.mywebsite.com/homepage.asp into browser 142A. Once this URL is entered into browser 142A, browser 142A will cause originating server 1100A to perform whatever operations are called for by the ASP script “homepage.asp.” In this way, the user, acting through browser 142A, is able to control and direct the operation of originating server 1100A.

On the other hand, some embodiments of transport software 140 are augmented with, or include, various objects 1202 and 1204 that can be “called,” or invoked, by originating server 1100A and/or destination server 1100B, in response to web server instructions, to perform various operations respecting one or more electronic documents 900. Such objects may take a variety of forms including, but not limited to, Microsoft® ActiveX components, and Component Object Models (“COM”).

Initiation of the logic embodied in such objects is typically accomplished by way of the server. By way of example, browser 142A may direct originating server 1100A to perform one or more actions respecting an electronic document 900 in accordance with a routine embodied in a particular object that is specified by the URL entered into browser 142A. Examples of such objects include encrypt/decrypt modules 1206A and 1206B, discussed below.

The functionalities implemented by web server instructions such as scripts and objects vary widely. For example, such web server instructions may serve to, among other things, direct servers such as originating server 1100A and destination server 1100B in the handling, storage, and transportation of electronic documents 900. Yet other web server instructions may serve to direct the action of originating server 1100A and/or destination server 1100B with respect to the processing and modification of electronic documents 900. As yet another example, web server instructions may be provided which allow a web server to interact with one or more databases.

Further, the configuration of transport software 140 may be varied as necessary to suit a particular application. By way of example, some embodiments of transport software 140 include both objects and scripts, while other embodiments of transport software 140 are limited solely to scripts and do not include objects. Embodiments of transport software 140 which comprise only scripts may function independently, or may cause a server to perform various actions in accordance with certain predefined objects not included in transport software 140. Other aspects of transport software 140 such as, but not limited to, the number and location of scripts and objects may be varied as necessary to suit the requirements of a particular application.

Finally, the various functionalities embodied individually and collectively in the objects and scripts of the present invention may be allocated between such objects and scripts in a variety of different ways, consistent with the requirements of a particular application. Accordingly, the scope of the present invention should not be construed to be limited solely to the exemplary allocation of functionalities disclosed herein.

Although operations respecting electronic documents 900 are preferably performed in accordance with logic embodied in scripts and/or objects, various other technologies may alternatively be employed to provide the functionality and logic embodied in such scripts and objects. Such other technologies include, but are not limited to, File Transfer Protocol (“FTP”), Secure File Transfer Protocol (“FTP(S)”), Database to Database directly with Structured Query Language (“SQL”) Server Internet Protocol (“IP”) calls, electronic mail, Lightweight Directory Access Protocol (“LDAP”) with Microsoft® Active Directory Services Interface (“ADSI”), Virtual Private Network (“VPN”), Peer-to-Peer, and Simple Object Access Protocol/Web Services Descriptor Language (“SOAP/WDSL”).

With continuing reference now to FIG. 7, originating server 1100A and/or destination server 1100B each has an associated audit log 1300A and 1300B, respectively. Generally, audit logs 1300A and 1300B serve to record the various processes performed with respect to electronic documents 900 as a result of operations specified by transport software 140. Thus, audit logs 1300A and 1300B enable ready reconstruction of the history of processes and operations performed by the servers with respect to a particular electronic document 900. In addition to audit logs, at least some embodiments of the present invention include various tables for retrievably storing routing, account, and other information. Two examples of such tables are account information table 1502 and routing information table 1504.

Finally, embodiments of the present invention may include systems, code, logic, and/or software for encrypting and decrypting, as applicable, electronic documents 900 transferred between originating server 1100A and/or destination server 1100B. Such encryption and decryption functionality is represented in FIG. 7 as objects in the form of encrypt/decrypt modules 1206A and 1206B. Such encrypt/decrypt modules may reside on originating server 1100A and/or destination server 1100B, respectively, or may be located remotely and accessed by originating server 1100A and/or destination server 1100B. Alternatively, the functionality implicated by encrypt/decrypt modules 1206A and 1206B may be incorporated, either wholly or partially, in transport software 140 in the form of web server instructions.

In an alternative embodiment, transport software 140 includes appropriate application program interfaces (“API”) to facilitate interoperability of transport software 140 with various third party encryption technologies.

The functionality embodied by encrypt/decrypt modules 1206A and 1206B may take a variety of forms, including, but not limited to, secure socket layer (“SSL”), technology, public key infrastructure (“PKI”) technology, secure hypertext transfer protocol (“S-HTTP” or “HTTPS”), or various combinations thereof. The type, or types, of encryption technology employed may be varied as necessary to suit a particular application. Note that in at least some embodiments of the invention, the SSL technology is initialized simply by using S-HTTP in the URL. In other embodiments, the SSL technology is called from within a script associated with the originating or destination server, as applicable.

Directing continuing attention to FIG. 7, more specific details are provided regarding various aspects of creation module 140A and processing module 140B of transport software 140. In the illustrated embodiment, creation module 140A and processing module 140B each comprise two sets of web server instructions. In at least one embodiment, such sets of web server instructions take the form of ASP scripts. Specifically, creation module 140A comprises ASP script I 1402, designated “DocSend.asp,” and ASP script IV 1408, designated “DocReceive.asp.” Processing module 140B comprises ASP script II 1404, designated “DocReceive.asp,” and ASP script III 1406, designated “DocReturn.asp.”

The modules and ASP scripts disclosed herein, as well as their respective designations, are exemplary only and are not intended to limit the scope of the present invention in any way. Consistent with the foregoing, the logic and functionality associated with creation module 140A and/or processing module 140B may be varied, supplemented, or re-allocated, as required to suit a particular application.

Before transport software 140 is initialized however, electronic document 900 may be processed at originating server 1100A. The step for processing electronic document 900 at originating server 1100A may be implemented by various acts or combinations of acts. Exemplary acts include, but are not limited to, entering data in electronic document 900, digitally signing electronic document 900, and digitally notarizing electronic document 900.

Directing attention now to FIGS. 8A through 8E, and with continuing attention to FIG. 7, an embodiment of a method 1600 suitable for transferring electronic documents between servers and/or systems such as originating server 1100A and processing server 1100B is illustrated. In this embodiment, ASP script I 1402 and IV 1408 are associated with originating server 1100A, and ASP script II 1404 and III 1406 are associated with destination server 1100B, and the general relationships between and among the respective scripts are as indicated in FIG. 8A. Note that while the embodiment of method 1600 illustrated in FIGS. 8A through 8E indicates a particular order in which certain steps and/or actions take place, this exemplary order need not necessarily be adhered to in all applications. Rather, the order of at least some of such steps and actions may be modified to suit the requirements of a particular application.

Directing attention specifically to FIG. 8B, reference is first made to ASP script I 1402, associated with originating server 1100A. Generally, ASP script I 1402 directs originating server 1100A to perform various actions relating to the preparation and transmission of electronic documents 900 stored in database 902A. The initialization of ASP script I 1402 occurs when a user inputs an appropriate URL, for example, http://www.creatingserver.com/docsend.asp, to originating server 1100A, by way of browser 142A. After such URL has been input to originating server 1100A, ASP script I 1402 causes originating server 1100A to retrieve (1602) an electronic document 900 from database 902A. In one embodiment, this retrieval step is defined by an object such as the third party ActiveX Data Object Database (“ADODB”).Connection object. Alternative objects or scripts having the same functionality may likewise be employed however.

Depending upon the application, one, or more than one, electronic documents 900 may be retrieved from database 902A at any given time. As noted elsewhere herein, such electronic document 900 may comprise any type of text file. For example, in one embodiment of the invention, electronic document 900 is created in extensible markup language (“XML”) format, which is readable both by machines and by humans.

Next, a package is created (1604) in which electronic document 900 will be deposited prior to being sent to destination server 1100B. In one embodiment, such packaging is defined by an object such as the third party “MSXML2.DOMDocumenf” object.

Various information relating to electronic document 900 is then associated (1606) with electronic document 900. Generally, associating information with electronic document 900 enables a user to readily define and control various aspects concerning the handling of electronic documents 900. In one embodiment, such information includes at least routing information, such as the URL of originating server 1100A and the URL of destination server 1100B, that is stored in routing information table 702. Such information may additionally, or alternatively, include information such as the account information stored in account information table 704. In still other embodiments, such information may additionally, or alternatively, include URLs for other servers as well. Finally, such information may take a variety of forms including, but not limited to, XML tags.

The step for associating information with electronic document 900, or the package in which electronic document 900 is contained, may be implemented by any of a variety of acts, or combinations of acts. For example, in one embodiment of the invention, the step for associating information with electronic document 900 is implemented by the act of embedding the information directly in electronic document 900. In an alternative embodiment, the step for associating information with electronic document 900 is implemented by the act of creating a package and depositing electronic document 900 and information in the package. In yet another embodiment, the step for associating information with electronic document 900 may be implemented by the act of connecting information to electronic document 900. In the act of connecting information to electronic document 900, such information may take the form of a file or other structure, containing appropriate information, that is removably attached to electronic document 900. Of course, the foregoing are exemplary acts and the scope of the present invention should, accordingly, not be construed to be limited solely to such acts.

Next, some or all of the information associated (1606) with electronic document 900 is subjected (1607) to a validation inquiry. For example, if the information associated with electronic document 900 comprises routing information such as a URL, ASP script I 1402 causes originating server 1100A to validate the URL by attempting to establish communication with the server with which such URL corresponds. If communication is established, the routing information is thereby validated. On the other hand, if communication cannot be established, the routing information is deemed invalid, and an appropriate error message is displayed (1608). Alternative routing information must be associated with electronic document 900.

Validation of the information associated with electronic document 900 is not concerned solely with routing information. Rather, any information, or subset thereof, associated with electronic document 900 may be validated. The scope and nature of such validation may be defined as necessary to suit the requirements of a particular application.

Finally, the validation inquiry (1607) may be performed at alternate points in method 1600. For example, in one embodiment of the invention, the validation inquiry (1607) is performed prior to creation (1604) of the package which contains electronic document 900.

Electronic document 900 is next rendered reversibly unreadable (1609) by an object such as encrypt/decrypt module 1206A so that only selected parties who have satisfied various predetermined criteria, may access, read, and/or modify electronic document 900. As noted earlier, such functionality may alternatively be embodied in the form of web server instructions, such as an ASP script, callable by originating server 1100A in response to instructions received by way of browser 142A. In the event all, or a portion, of a transmitted electronic document 900 were intercepted, the aforementioned step performed by encrypt/decrypt module 1206A ensures that any such intercepted material would be unreadable and incapable of modification by the intercepting party. This step is useful in a variety of applications, for example, where secure transmission of sensitive documents is desired.

Note that the step for rendering electronic document 900 reversibly unreadable (1609) may be performed at an alternative point within method 1600, as necessary to suit the requirements of a particular application. For example, the step for rendering electronic document 900 reversibly unreadable (1609) may be performed immediately prior to the validation inquiry (1607). As another example, the step for rendering electronic document 900 reversibly unreadable (1609) may be performed immediately following retrieval (1602) of electronic document 900 from database 902A.

The step for rendering at least a portion of electronic document 900 reversibly unreadable may be implemented by any of a variety of acts. For example, in one embodiment of the invention, the step for rendering at least a portion of electronic document 900 reversibly unreadable is implemented by the act of encrypting such portion of electronic document 900. Alternative acts, or combinations thereof, may also be employed to implement the step for rendering a portion of electronic document 900 reversibly unreadable. In one embodiment of the invention, such encryption functionality takes the form of SSL technology.

After a portion of electronic document 900 has been rendered reversibly unreadable, electronic document 900, or the package which contains electronic document 900, is posted to destination server 1100A (1610). In one embodiment of the invention, such posting is facilitated by an object such as the third party “MSXML2.ServerXMLHttp” object.

At such time as the package, or electronic document 900 with associated information, is posted to destination server 1100B, the package or electronic document 900 is then transferred, from originating server 1100A to the URL or URLs specified in the routing information. As noted above, at least one such URL is the URL associated with originating server 1100B.

The step for transferring electronic document 900 from an originating server to a destination server may be implemented by any of a variety of acts. For example, in one embodiment of the invention, the step for transferring electronic document 900 from an originating server to a destination server is implemented by the act of posting electronic document 900 to one or more servers.

Upon the transfer of electronic document 900, or the package which contains electronic document 900, the initial response of destination server 1100B to the posting of the electronic document 900, or the posting of the package containing electronic document 900, is received (1612). In particular, information associated with electronic document 900 by destination server 1100B is received at originating server 1100A. Such information may also include, but is not limited to, the date and/or time of transmission of electronic document 900, the date and/or time of receipt of electronic document 900 at destination server 1100B, and whether or not electronic document 900 passed the initial validation (see 1621 in FIG. 8C) performed at destination server 1100B. The information thus received is then stored (1614) in audit log 1300A. In one embodiment of the invention, the process for such storing is facilitated by a script such as a “clsSystemAudit.asp” script.

Finally, the results of the posting of electronic document 900, or the package containing electronic document 900, to the destination server are displayed (1616). Typically, such results include, but are not limited to, identifying the fact of transmission of the package or electronic document 900, identifying the server or servers to which the electronic document 900 or package was transmitted, and/or other appropriate information relating to such transmission. Such results may also include information associated with electronic document 900 by originating server 1100A and/or information, such as the tracking number, assigned to electronic document 900 by destination server 1100B. Typically, the display of the posting results is implemented by way of browser 142A.

After electronic document 900, or the package containing electronic document 900, has been received at destination server 1100B, ASP script II 1404 is initialized. In one embodiment of the invention, ASP script II 1404 is initialized by inputting an appropriate URL, for example http://www.processingserver.con/docreceive.asp, to destination server 1100B by way of browser 142B. In general, ASP script II 1404 causes destination server 1100B to receive electronic document 900 and perform at least some initial processing of electronic document 900.

Directing attention now to FIG. 8C, after such time as ASP script II 1404 is initialized, the posted package is received at destination server 1100B (1617). In one embodiment of the invention, the posted package is received into a Document Object Model (“DOM”) object using a third party object such as the MSXML2.DOMDocument object. Other objects and/or scripts having the same functionality may alternatively be employed however. An appropriate object is then created (1618). In one embodiment of the invention, an InBox object is created from IGInBox.dll.

Next, electronic document 900, or the package containing electronic document 900, is subjected (1620) to an initial validation. The step for performing an initial validation of electronic document 900, or the package containing electronic document 900, may be implemented by a variety of acts or combinations of acts. For example, in one embodiment of the invention, the step for performing an initial validation of electronic document 900, or the package containing electronic document 900, is implemented by the act of examining the package to various predetermined criteria to see if the package contains at least an electronic document 900 and associated information. As discussed herein, in at least one embodiment of the invention, such associated information comprises routing information, for example, the address of originating server 1100A. Other information may additionally, or alternatively, be associated with electronic file 900.

In this exemplary embodiment, the step for performing an initial validation thus focuses primarily on structural aspects of the package, and not on the specific contents of electronic document 900 or the nature or content of the associated information. However, the nature and scope of such initial validation may be defined as necessary to suit the requirements of a particular application. Thus, in some embodiments, both the structural and content aspects of the package are the subjects of the initial validation. In yet other embodiments, the initial validation is concerned solely with the contents of electronic document 900 and/or the associated information.

In the event the package or electronic document 900 fails the initial validation, ASP script III 1404 causes destination server 1100B to retrieve (1622) an error string from database 902B. In general, the error string corresponds to the reason(s) for the failure of the package or electronic document 909 to pass the initial validation. For example, in one embodiment of the invention, the error string contains data or information which identifies the specific reason(s) for failure of the package to pass the initial validation.

In at least one embodiment of the invention, retrieval of the error string is facilitated by a third party object such as an ADODB.Connection object, and the packaging process results in the formation of a third party document type such as MSXML2.DOMDocument.” However, various other scripts and/or documents types may alternatively be employed.

After retrieval of the error string, the routing information that accompanied electronic document 900 upon posting of the package to destination server 1100B is retrieved from database 902B and packaged (1624) with the retrieved error string. As discussed elsewhere herein, such routing information includes, in at least some embodiments, the URL of originating server 1100A. In one embodiment of the invention, the retrieval of the routing information is facilitated by a third party object such as the “ADODB.Connection” object.

Finally, the package containing the error string and the routing information is posted (1626) at least to originating server 11 00A, consistent with the routing information. In one embodiment, such posting is facilitated by an object such as the third party “MSXML2.ServerXMLHttp” object.

If, on the other hand, electronic document 900, or the package containing electronic document 900, received at destination server 1100B passes the initial validation step, ASP script II 1404 causes destination server 1100B to assign a tracking number to electronic document 900 and immediately transmit the tracking number to originating server 1100A (1628). Next, ASP script II 1404 causes destination server 1100B to store (1629) the received package or electronic document 900 in database 902B and place (1630) the package or electronic document 900 in the destination server 1100B processing queue, as indicated in FIG. 8D.

Prior to subsequent processing of electronic document 900 (see 1632), electronic document 900 is retrieved and rendered into a readable state (1631) by encrypt/decrypt module 1206B. In general, a readable state refers to the state wherein electronic document 900 can be read both by humans and by a machine such as a computer, and also to the state where electronic document 900 is readable only by a machine.

The step for rendering at least a portion of electronic document 900 into a readable state may be implemented by any of a variety of acts. For example, in one embodiment of the invention, the step for rendering at least a portion of electronic document 900 readable is implemented by the act of decrypting such portion. Alternative acts, or combinations thereof, may also be employed to implement the step for rendering a portion of electronic document 900 readable. In one embodiment of the invention, such decryption functionality takes the form of SSL technology.

After electronic document 900 has been rendered into a readable state, one or more of such electronic documents 900 may then be processed (1632) in accordance with the main procedure of destination server 1100B, as described elsewhere herein. After processing, the processed electronic document 900 is returned (1633) to database 902B.

Various acts or combinations of acts may be employed to implement the step for processing electronic document 900 at destination server 1100B. Such acts include, but are not limited to, digitally validating electronic document 900, digitally endorsing electronic document 900, indexing electronic document 900, imaging electronic document 900, and archiving electronic document 900.

Note that during processing (1630) of electronic document 900, it may become apparent that electronic document 900 is defective in some regard, for example, with reference to the content and/or form of electronic document 900. For example, electronic document 900 may contain inaccurate data, such as errors in the legal description of property to be conveyed. As another example, electronic document 900 may include improper fonts. As yet another example, electronic document 900 may contain one or more improper or invalid digital signatures. In the event it is determined that electronic document 900 is defective in some regard, a rejection notice is generated at destination server 1100B and stored in database 902B for subsequent packaging with electronic document 900 and transmission to originating server 1100A.

With reference now to FIGS. 7, 8A and 8D, details will now be provided regarding the return of processed electronic documents 900 from destination server 1100B to originating server 1100A. Electronic documents 900 which pass the initial validation are ultimately returned to originating server 1100A in accordance with ASP script III 1406. In one embodiment of the invention, ASP script III 1406 is initiated by inputting an appropriate URL, for example http://www.processingserver.com/docreturn.asp, to destination server 1100B by way of browser 142B. Note that in one alternative embodiment, it is ASP script II 1404 that returns electronic documents 900 to originating server 1100A. In yet another embodiment, it is ASP script III 1406 that returns electronic documents 900 to originating server 1100A. Such alternative embodiments exemplify the flexibility that the use of scripts and objects permit with respect to operations performed concerning electronic document(s) 900.

At some point after completion of any processing of electronic document 900 by destination server 1100B, ASP script III 1406 causes electronic document 900 to be retrieved (1634) by destination server 1100B from database 902B. In one embodiment of the invention, such retrieval is facilitated by a third party object such as the ADODB.Connection object. Alternative objects or scripts having the same functionality may likewise be employed however.

A package is then created (1636) that includes electronic document 900, and a receipt is associated (1638) with electronic document 900. Various acts may be employed to implement the step for associating a receipt with electronic document 900. In one embodiment, the step for associating a receipt with electronic document 900 may be implemented by the acts of retrieving a receipt from database 902B and disposing the receipt in the package with electronic document 900. In an alternative embodiment, no package is formed and the step for associating a receipt with electronic document 900 may be implemented by the acts of retrieving a receipt from database 902B and embedding the receipt in electronic document 900.

After the package is completed, routing and/or other information is associated (1640) with electronic document 900. As noted earlier, the step for associating routing information with electronic document 900 may be implemented by any of a variety of acts. By way of example, a URL corresponding to originating server 1100A is retrieved from database 902B. In one embodiment, such retrieval is facilitated by a third party object such as the ADODB.Connection object. Alternative objects, or scripts, having the same functionality may likewise be employed however.

Finally, the tracking number, previously generated and transmitted to originating server 1100A (see 1628), is associated (1642) with electronic document 900. Similar to the case of routing information or other information, the step for associating the tracking number with the electronic document 900 may be implemented by a variety of acts. One example of such an act is the act of embedding the tracking number in electronic document 900. Another example is the act of attaching the tracking number to electronic document 900.

After the tracking number and/or other information has been associated with the received electronic document 900, or package within which electronic document 900 is contained, at least a portion of electronic document 900 is rendered reversibly unreadable (1643). The step for rendering electronic document 900 reversible unreadable may, however, be performed at various alternate points in method 1600. For example, the step for rendering electronic document 900 reversible unreadable may alternatively be performed immediately after retrieval (1634) of electronic document 900 from database 902B.

Next, the package or electronic document 900 is posted (1644) to originating server 1100A, or other server(s) to which the routing information corresponds. In one embodiment, such posting is facilitated by an object such as the third party “MSXML2.ServerXMLHttp” object. Alternative objects, or scripts, having the same functionality may likewise be employed however.

With reference now to FIG. 8E, after the electronic document 900, or the package containing electronic document 900, is posted to originating server 1100A, ASP script IV 1408 is initialized. Note that ASP script IV 1408 is initialized whether or not such electronic document 900 has failed the initial validation, or has passed the initial validation and/or has subsequently been rejected. In one embodiment of the invention, ASP script IV 1408 is initialized by inputting an appropriate URL, for example http://www.creatingserver.com/docreceive.asp, to originating server 1100A by way of browser 142A. In general, ASP script IV 1408 causes originating server 1100A to receive electronic document 900, or a package containing electronic document 900 or otherwise related to package 900, and to perform various operations concerning the received electronic document 900.

The posted package or electronic document 900 is received (1645) at originating server 1100A. Next, originating server 1100A first initializes (1646) an object, such as encrypt/decrypt module 1206A, to decrypt the returned electronic document 900. However, if an error string was generated upon posting of electronic document 900 to destination server 1100B, the electronic document 900 is not returned to originating server 1100A, and no decryption is necessary. The originating server 1100A then examines (1648) the returned package or electronic document 900 to determine what changes, if any, have been made to electronic document 900 by destination server 1100B, or other servers to which electronic document 900 was initially sent. In one embodiment of the invention, used in conjunction with the preparation and recording of legal electronic documents, ASP script IV 1408 causes originating server 1100A to determine whether or not electronic document 900 was recorded or rejected by destination server 1100B.

ASP script IV 1408 causes a status value of electronic document 900 to be altered (1650) to reflect what action or actions were taken with respect to electronic document 900 by destination server 1100B. For example, if an electronic document 900 has been recorded by destination server 1100B, ASP script IV 1408 would cause originating server 1100A to assign a “Recorded” status to the electronic document. As another example, an electronic document 900 that has been rejected by destination server 1100B as a result of one or more defects may be assigned a “Rejected” status. Further, in the event an error string was returned concerning electronic document 900, originating server 1100A simply updates the status value of electronic document 900 to indicate, for example, “Failed Initial Validation.”

ASP script IV 1408 causes originating server 1100A to place (1652) electronic document 900 into an appropriate table in database 902A. In general, such table corresponds to the status of electronic document 900 and/or may also correspond to various processes performed with respect to the electronic document. By way of example, a electronic document 900 having an associated rejection notice may be placed in a database 902A table entitled “Rejected Documents.” Note that if an error string was returned concerning electronic document 900, electronic document 900 was not returned to originating server 1100A, and thus no placement (1652) of electronic document 900 into a table can occur.

Finally, ASP script IV 1408 causes originating server 1100A to store (1654) corresponding information in audit log 1300A. In one embodiment of the invention, the information stored in audit log 1300A comprises an enumeration of the various processes or actions taken by originating server 1100A and destination server 1100B regarding electronic document 900. For example, audit log 1300A may include the following entries: “Created,” Transmitted to Processing Server,” “Date of Transmission to Processing Server,” “Verified by Processing Server,” “Recorded by Processing Server,” and “Returned to Creating Server.” Such entries are exemplary however, and a variety of additional or alternative entries may be employed consistent with the requirements of a particular application. One advantage of such audit logs is that they permit ready reconstruction of the history of a particular electronic document 900.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. In a computer network including an originating server and a destination server configured for communication with each other, a method suitable for transferring an electronic document, the method comprising the steps for:
rendering a portion of the electronic document reversibly unreadable;
creating a first package comprising the electronic document and routing information;
transferring said first package, consistent with said routing information, from the originating server to the destination server;
performing an initial validation of said first package;
returning a response to the originating server corresponding to the results of said initial validation;
creating a second package including routing information; and
transferring said second package, consistent with said routing information, from the destination server to the originating server.

2. The method as recited in claim 1, further comprising the step for processing the electronic document at the originating server.

3. The method as recited in claim 2, wherein the step for processing the electronic document comprises at least one act selected from the group consisting of: entering data in the electronic document, digitally signing the electronic document, and digitally notarizing the electronic document.

4. The method as recited in claim 1, further comprising the step for processing the electronic document at the originating server.

5. The method as recited in claim 4, wherein the step for processing the electronic document at the destination server comprises at least one act selected from the group consisting of: validating the electronic document, endorsing the electronic document, recording the electronic document, imaging the electronic document, indexing the electronic document, and archiving the electronic document.

6. The method as recited in claim 1, further comprising the act of returning an error string to the originating server if said first package fails said initial validation.

7. The method as recited in claim 1, further comprising the act of returning a tracking number to the originating server if said first package passes said initial validation.

8. The method as recited in claim 1, further comprising the step for associating a receipt with the electronic document.

9. The method as recited in claim 1, further comprising the step for rendering a portion of the electronic document reversibly unreadable prior to transfer from the destination server, and the step for rendering the electronic document into a readable state after the electronic document has been transferred to the originating server.

10. The method as recited in claim 1, further comprising the step for performing a validation inquiry regarding said routing information.

11. In a computer network including an originating server and a destination server configured for communication with each other, a method suitable for transferring an electronic document, the method comprising:
the step for processing the electronic document at the originating server;
the act of encrypting at least a portion of the electronic document;
the step for associating at least routing information with the electronic document;
the act of posting the electronic document, consistent with said routing information, to the destination server;
the act of decrypting the electronic document;
the step for processing the electronic document at the destination server; and
the act of posting the electronic document, consistent with said routing information, to the originating server.

12. The method as recited in claim 11, further comprising the step for performing an initial validation of the electronic document.

13. The method as recited in claim 12, further comprising the act of returning an error string to the originating server if the electronic document fails said initial validation.

14. The method as recited in claim 12, further comprising the act of returning a tracking number to the originating server if the electronic document passes said initial validation.

15. The method as recited in claim 11, further comprising the step for associating a receipt with the electronic document.

16. The method as recited in claim 11, wherein the step for associating at least routing information with the electronic document comprises the act of embedding routing information in the electronic document.

17. The method as recited in claim 11, wherein the step for associating at least routing information with the electronic document comprises the act of embedding in the electronic document a uniform resource locator of the destination server and a uniform resource locator of the originating server.

18. The method as recited in claim 11, further comprising the step for performing a validation inquiry regarding said at least routing information.

19. In a computer network including an originating server and a destination server configured for communication with each other, a computer program product for implementing a method suitable for transferring electronic documents, the computer program product comprising:
a computer-readable medium carrying computer executable instructions for performing the method, wherein the method comprises the steps for:
processing the electronic document at the originating server;
rendering at least a portion of the electronic document reversibly unreadable;
associating at least routing information with the electronic document;
transferring the electronic document, consistent with said routing information, from the originating server to the destination server;
rendering the electronic document into a readable state;
processing the electronic document at the destination server; and
transferring the electronic document, consistent with said routing information, from the destination server to the originating server.

20. The computer program product as recited in claim 19, wherein the step for processing the electronic document at the originating server comprises at least one act selected from the group consisting of: entering data in the electronic document, digitally signing the electronic document, and digitally notarizing the electronic document.

21. The computer program product as recited in claim 19, wherein the step for processing the electronic document at the destination server comprises at least one act selected from the group consisting of: validating the electronic document, endorsing the electronic document, recording the electronic document, imaging the electronic document, indexing the electronic document, and archiving the electronic document.

22. The computer program product as recited in claim 19, further comprising the step for performing an initial validation of the electronic document.

23. The computer program product as recited in claim 22, further comprising the act of returning a tracking number to the originating server if the electronic document passes said initial validation.

24. The computer program product as recited in claim 22, further comprising the act of returning an error string to the originating server if the electronic document fails said initial validation.

25. The computer program product as recited in claim 19, further comprising the step for associating a receipt with the electronic document.

26. The computer program product as recited in claim 19, further comprising the step for rendering a portion of the electronic document reversibly unreadable prior to transfer from the destination server, and the step for rendering the electronic document into a readable state after the electronic document has been transferred to the originating server.

27. The computer program product as recited in claim 19, further comprising the step for associating a tracking number with the electronic document.

28. The computer program product as recited in claim 19, further comprising the step for performing a validation inquiry regarding said at least routing information.

29. In a computer network including an originating server and destination server configured for communication with each other, a computer program product for implementing a method suitable for transferring electronic documents, the computer program product comprising:
a computer-readable medium carrying computer executable instructions for performing the method, wherein the method comprises:
the step for processing the electronic document at the originating server;
the act of encrypting at least a portion of the electronic document;
the step for associating at least routing information with the electronic document;
the act of posting the electronic document, consistent with said routing information, to the destination server;
the act of decrypting the electronic document;
the step for processing the electronic document at the destination server; and
the act of posting the electronic document, consistent with said routing information, to the originating server.

30. The computer program product as recited in claim 29, further comprising the step for performing an initial validation of the electronic document.

31. The computer program product as recited in claim 30, further comprising the act of returning an error string to the originating server if the electronic document fails said initial validation.

32. The computer program product as recited in claim 30, further comprising the act of returning a tracking number to the originating server if the electronic document passes said initial validation.

33. The computer program product as recited in claim 29, further comprising the step for associating a receipt with the electronic document when the electronic document is received at the destination server.

34. The computer program product as recited in claim 29, wherein the step for associating at least routing information with the electronic document comprises the act of embedding routing information in the electronic document.

35. The computer program product as recited in claim 29, wherein the step for associating at least routing information with the electronic document comprises the act of embedding in the electronic document a uniform resource locator of the destination server and a uniform resource locator of the originating server.

36. The computer program product as recited in claim 29, further comprising the step for performing a validation inquiry regarding said at least routing information.

37. In a computer network including an originating server and destination server configured for communication with each other, a computer program product for implementing a method suitable for transferring an electronic document created using extensible markup language and extensible hypertext markup language formats, the method comprising the steps for:
processing the electronic document at the originating server;
rendering at least a portion of the electronic document reversibly unreadable;
creating a package containing routing information and the electronic document;
transferring said package, consistent with said routing information, to the destination server;
rendering the electronic document into a readable state;
processing the electronic document at the destination server;
creating a package containing routing information and the electronic document;
transferring said package created at the destination server to the originating server, consistent with said routing information;
examining the electronic document to ascertain changes;
updating a status of the electronic document;
placing the electronic document into a table; and
updating an audit log.

38. The computer program product as recited in claim 37, wherein the step for processing the electronic document at the originating server comprises the acts of entering data in the electronic document, digitally signing the electronic document, and digitally notarizing the electronic document.

39. The computer program product as recited in claim 37, wherein the step for processing the electronic document at the destination server comprises the acts of validating the electronic document, endorsing the electronic document, recording the electronic document, imaging the electronic document, indexing the electronic document, and archiving the electronic document.

40. In a computer network including an originating database and a destination database configured to receive electronic files from each other, a method suitable for transferring an electronic document, the method comprising the steps for:
processing the electronic document;
rendering a portion of the electronic document reversibly unreadable;
associating at least routing information with the electronic document;
transferring the electronic document, consistent with said routing information, from the originating database to the destination database;
rendering the electronic document into a readable state;
processing the electronic document; and
transferring the electronic document, consistent with said routing information, from the destination database to the originating database.
